(19) United States
(12) Patent Application Publication
(10) Pub. No.: US 2023/0220215 A1
(43) Pub. Date: Jul. 13, 2023

(54) CURABLE COATING COMPOSITION AND COATED ARTICLE

(71) Applicant: GUANGDONG HUARUN PAINTS CO., LTD, Foshan City (CN)

(72) Inventors: Song NIU, Foshan City, Guangdong (CN); Shigang FAN, Foshan City, Guangdong (CN); Xi ZHAO, Foshan City, Guangdong (CN); James J. GALLAGHER, Cleveland, OH (US)

(21) Appl. No.: 18/000,405

(22) PCT Filed: Jun. 15, 2021
(86) PCT No.: PCT/IB2021/000397

§ 371 Date: Dec. 1, 2022

Related U.S. Application Data
(60) Provisional application No. 63/159,739, filed on Mar. 11, 2021.
(60) Provisional application No. 62/705,210, filed on Jun. 16, 2020.

(51) Int. Cl. C09D 4/06; C09D 167/06; C09D 167/02; C09D 163/00; C09D 161/00; C09D 135/04

(52) U.S. Cl. CPC C09D 4/06; C09D 167/06; C09D 167/02; C09D 163/00; C09D 161/00; C09D 135/04

(57) ABSTRACT

The present description provides a Michael Addition curable composition, comprising A) at least one reactive donor capable of providing two or more nucleophilic carbanions; B) at least one reactive acceptor comprising two or more carbon-carbon double bonds; and C) at least one catalyst for catalyzing the Michael Addition crosslinking reaction between the at least one reactive donor and the at least one reactive acceptor. The present description further provides a coating composition containing the composition and a coated article made therefrom.

The present application claims the benefit of U.S. Provisional Patent Application No. 62/705,210 filed Jun. 16, 2020, and U.S. Provisional Patent Application No. 63/159,739 filed on Mar. 11, 2021 which is incorporated herein by reference in its entirety.

### BACKGROUND

Coatings are frequently applied to various substrates, including wood, metal, plastic, ceramic, cement board, and other substrates to provide surface protection and/or prevent corrosion. These coatings are often multilayer coatings and are economical and relatively easy to apply. The coatings dry quickly and have good corrosion resistance and chemical resistance, making the coatings especially useful for coating components to be used over long periods of time and/or in corrosive environments.

Conventionally, these coatings are applied to substrate surfaces to provide surface and/or corrosion protection, and typically include epoxy resins, polyurethane resins, and the like as well as combinations thereof. Typically, such coating systems are crosslinkable two-component compositions, where the components are stored separately and mixed prior to use.

Two-component polyurethane systems are common in the industry, and typically include isocyanate-functional compounds. However, the human health risks and environmental issues associated with isocyanate-functional compounds are increasingly scrutinized. Free isocyanate is considered a serious human health hazard, and there is increased regulatory pressure to substantially reduce or eliminate use of isocyanate-functional compounds in coatings. Therefore, non-isocyanate curing (NISO or NICN) curing systems have generated significant interest in the field of coatings technology.

One potential NICN system of interest is the Michael Addition (MA) curing system. This system offers several advantages over traditional isocyanate-based curing systems, including cure at lower temperatures, longer pot life, and compatibility with high solids low volatile organic compound (VOC) systems. These MA systems typically include a catalyst to increase the rate of the crosslinking reaction between the two components. Base-catalyzed systems are preferred because they are capable or rapid or fast cure. However, because of the rapid rate of cure, these compositions can only be used for a relatively short period of time after the components are mixed, defined as the pot life of the coating composition. In some base-catalyzed systems, viscosity increases so rapidly that the coating cures before it can be fully applied to a surface, and accordingly, these systems are of limited practical use. This problem of reduced pot life in MA systems has been addressed by the use of a latent base catalyst for a one-coat system, as described in U.S. Pat. Nos. 8,962,725; 9,181,452; 9,181,453; 9,260,626; 9,284,423; 9,534,081; 9,587,1389,834,701; 10,017607, and related applications.

The MA curing system described in these patents suffers from some obvious disadvantages, however. For example, when cured at room temperature (a range of 20° C. to 27° C.), this system results in much lower film hardness relative to conventional two-component polyurethane systems. Moreover, the MA curing system described in these patents is not known to offer optimal adhesion and/or sufficient corrosion resistance when applied directly to certain substrates.

Accordingly, there is a need for improved MA curing systems that offer the advantages of improved cure and increased pot life and also demonstrate optimal adhesion, film hardness, and other important coatings performance characteristics.

### SUMMARY

The present description provides compositions and methods involving a Michael Addition (MA) reaction. The compositions described herein are MA curable compositions and demonstrate optimal cure performance and pot life. Coatings derived from the MA curable compositions described herein optimal mechanical and performance characteristics when applied to a substrate and cured.

In one aspect, the present description provides a Michael Addition (MA) curable composition, comprising:

A) at least one reactive donor capable of providing two or more nucleophilic carbanions;

B) at least one reactive acceptor comprising two or more carbon-carbon double bonds; and

C) a catalyst for catalyzing the Michael Addition crosslinking reaction between the at least one reactive donor and the at least one reactive acceptor,

wherein the catalyst comprises at least one quaternary salt with the following structural Formula I,

R¹R²R³R⁴M⁺X⁻ (Formula I)

in which formula,
R¹, R², R³ and R⁴ are each independently selected from C1-C12 alkyl, C6-C14 aryl, C7-C15 alkaryl, C7-C15 aralkyl and any combination thereof, or any two of R¹, R², R³ and R⁴ together with M atom to which they are attached form a heterocycle;
M is N or P, preferably N and
X⁻ is derived from at least one acid, at least one anhydride, or combinations thereof, having a pKa value in the range of 0 to 10, preferably in the range of 1 to 8 wherein the pKa value is measured in an aqueous solution of the at least one acid, the at least one anhydride, or combinations thereof at 25° C., and wherein X⁻ is not derived from an acid or anhydride of carbonic acid or carbamic acid.

In some embodiments, the MA curable composition described herein is such that after mixing components of the composition, the resulting mixture has pot life of at least 2 hours at 25° C.

In one embodiment, the MA curable composition described herein can be cured at room temperature (a range of 20° C. to 27° C.) or higher and within 7 days or less.

In some embodiments, the MA curable composition described herein may be used for manufacture of coatings, adhesives, sealing agents, foaming materials, films, molded products or inks.

In another aspect, the present description provides a coated article comprising a substrate having at least one major surface; and a cured coating formed from the MA coating composition described herein that is directly or indirectly at least partially applied on the major surface. Preferably, the substrate comprises wood, metal, plastic, ceramic, cement board, or any combination thereof.

The above summary of what is described herein is not intended to describe each disclosed embodiment or every implementation. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments described herein are set forth in the accompanying drawings and the description below. Other features, objects, and advantages will be apparent from the description and drawings, and from the claims.

### SELECTED DEFINITIONS

As used herein, “a”, “an”, “the”, “at least one”, and “one or more” are used interchangeably. Thus, for example, a coating composition that comprises “an” additive can be interpreted to mean that the coating composition includes “one or more” additives.

The term “component” refers to any compound that includes a particular feature or structure. Examples of components include compounds, monomers, oligomers, polymers, and organic groups contained there.

The term “double bond” is non-limiting and refers to any type of double bond between any suitable atoms (e.g., C, O, N, etc.). As used herein in the context of at least one reactive acceptor, the term refers to a structure containing a carbon-carbon double bond, but not including an aromatic ring. The term “ethylenically unsaturated” is used interchangeably herein with “double bond.”

As used herein, the term “Michael Addition” refers to the nucleophilic addition of a carbanion provided by at least one reactive donor to an electrophilic conjugated system such as carbon-carbon double bond of at least one reactive acceptor. A Michael Addition reaction follows the general reaction schematic shown here:

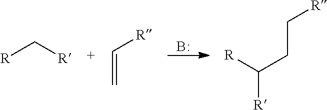

In the reaction schematic shown above, substituents R and R′ on the at least one reactive donor are electron-withdrawing groups, such as acyl, keto, and cyano groups, so that the hydrogen on methylene of the at least one reactive donor can be deprotonated and form a carbanion in the presence of a catalyst B: and the at least one reactive acceptors usually comprise α, β-unsaturated ketones, aldehydes, carboxylic acids, esters, nitriles, nitro and other compounds.

As used herein, the term “quaternary salt” refers to a quaternary ammonium salt and/or quaternary phosphonium salt having an anionic group. In one embodiment, the quaternary salt is a quaternary ammonium salt. As an exemplary illustration, the quaternary ammonium salt may be formed by reacting a tertiary amine having a lone pair of electrons with an acid having a hydrogen ion, or the quaternary ammonium salt may be formed by reacting a quaternary ammonium base with an acid having a hydrogen ion.

As used herein, the term “pKa” refers to the negative logarithm value of the dissociation constant (Ka) of an acid or anhydride in an aqueous solution. The smaller the pKa value, the easier to dissociate hydrogen ions from acid or anhydride, and the stronger the acidity of acid or anhydride. In the present description, the pKa value is obtained by measuring dissociation constants of the acid or anhydride in an aqueous solution at 25° C. and taking a negative logarithm value for the measured dissociation constants. Where an acid anhydride is used, the pKa value refers to the pKa value of an acid formed by the acid anhydride in an aqueous solution. Where there are multiple dissociations of the acid or anhydride in an aqueous solution, the pKa of the acid or anhydride is determined based on the first-order dissociation constant (Ka1).

As used herein, the term “epoxy functional component” refers to a component having at least one epoxy functional group. In the MA curable composition described herein, the epoxy functional component may be a reactive donor, a reactive acceptor, or another component. As an exemplary illustration, the epoxy functional group of the epoxy functional component may be derived from glycidyl ether, glycidyl ester, epoxy functional alkane, epichlorohydrin, epoxy resin, and the like.

When used herein, the term “metal oxide”, as the name implies, refers to a binary compound formed from a metal element and an oxygen element and the binary compound can dissociate metal ions. Similarly, the term “metal salt” refers to a compound formed by bonding one or more metal ions and acid radical ions through ionic bonds and this compound can dissociate metal ions.

The term “pH” in the context of “ metal oxide or metal salt”, refers to a parameter used to measure the acidity and alkalinity of the metal oxide or metal salt, which is tested by dispersing 5 grams of the metal oxide or salt in 100g of an aqueous medium (for example, deionized water with a pH of 7.0) uniformly to form an aqueous dispersion, and then measuring the pH value of the resulting aqueous dispersion several times with a pH tester of model BPH-220 followed by taking an average. In some embodiments described herein, the metal oxide or metal salt is weakly alkaline and has a pH in the range of 8-12.

As used herein, the term “curing” refers to a process in which a composition undergoes a cross-linking chemical reaction, thereby changing from a liquid, fluid, or gel state to a solid state. When referring to “Michael addition curable compositions”, the term “cure time” refers to the time required for the mixture to polymerize and cure and exhibit effective end-use properties.

When referring to “Michael addition-curable composition”, the term “tack-free time” means that the time required for the resulting coating as obtained by mixing the components of the composition at a specific temperature to form a mixture and applying the mixture to the test substrate in a specific wet coating thickness (for example, 100 μm) to reach not to stick hands, for example, by touching. In some embodiments, the track free time can also be tested by other methods known in the art.

When referring to “Michael addition-curable composition”, the term “gel time” refers to the time required for the resulting mixture as obtained by mixing the components of the composition at a specific temperature to reach a non-flowable gel state. In the embodiment described herein, the gel time is a parameter used to measure the curing activity of the Michael addition curing system.

As used herein, the term “ambient temperature” refers to the surrounding temperature in a typical indoor environment. typically in the range of 15° C. to 40° C., preferably in the range of 20° C. to 27° C. The term “room temperature” is used interchangeably herein with “ambient temperature.”

As used herein, the term “pot life,” refers to a period of time after mixing components of a Michael Addition-curable composition or coating composition. In particular, it refers to the time required for viscosity of the mixed components to become twice its original viscosity. The term is used interchangeably herein with “gel time.”

The term “nucleophilic carbanion” in the context of a reactive donor, refers to an active intermediate of carbon with a lone pair of electrons to which two or three strong electronegative groups are attached. The strong electronegative groups may include, but is not limited to, —NO₂, —C(═O)—, —CO₂R₁, —SO₂—, —CHO, —CN, and —CONR₂, etc., wherein R₁ and R₂ each independently represent an alkyl group. In some embodiments described herein, the nucleophilic carbanion is derived from an acidic proton C—H in an activated methylene, methine group, or combinations thereof.

The term “major surface”, when used in the context of a substrate, refers to a surface formed by lengthwise and widthwise dimensions of the substrate for providing decoration.

The term “on,” when used in the context of a coating composition applied on a major surface of substrate, includes the coating composition applied directly or indirectly to the major surface of the substrate. In some embodiments, the coating composition described herein is applied directly to a major surface of substrate to form a coating. In other embodiments, there may be one or more barrier layers or adhesion promoting layers between the coating composition described herein and the substrate.

The term “volatile organic compound” (“VOC”) refers to any compound of carbon, excluding carbon monoxide, carbon dioxide, carbonic acid, metallic carbides, or carbonates, and ammonium carbonate, which participates in atmospheric photochemical reactions. Typically, volatile organic compounds have a vapor pressure equal to or greater than 0.1 mm Hg. As used herein, “volatile organic compound content” (“VOC content”) means the weight of VOC per volume of the composition or coating composition, and is reported, for example, as kilogram (kg) of VOC per liter as measured by ISO 11890-1: 2007.

The term “comprises”, “comprising”, “contains” and variations thereof do not have a limiting meaning where these terms appear in the description and claims.

The terms “preferred” and “preferably” refer to embodiments described herein that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of what is described herein.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides methods and compositions for application to a variety of substrates including wood, plastic, metal, ceramic, cement board, and other substrates. Specifically, the present description provides coating compositions or systems derived from components that cure via a Michael addition reaction, i.e. a Michael Addition (MA) curable composition or system. In an embodiment, the present description provides a Michael Addition curable system or composition. The composition includes A) at least one reactive donor capable of providing two or more nucleophilic carbanions; B) at least one reactive acceptor comprising two or more carbon-carbon double bonds; and C) a catalyst for catalyzing the Michael Addition crosslinking reaction between the at least one reactive donor and the at least one reactive acceptor,

wherein the catalyst is at least one quaternary salt having the structure of a compound of Formula I,

R¹R²R³R⁴M⁺X⁻ (Formula I)

wherein
R¹, R², R³ and R⁴ are each independently selected from C1-C12 alkyl, C6-C14 aryl, C7-C15 alkaryl, C7-C15 aralkyl and any combination thereof, or any two of R¹, R², R³ and R⁴ together with M atom to which they are attached form a heterocycle;
M is N or P, preferably N; and
X⁻ is derived from at least one acid, at least one anhydride, or combinations thereof having a pKa value in the range of 0 to 10, preferably in the range of 1 to 8 wherein the pKa value is obtained by measuring an aqueous solution of the at least one acid, the at least one anhydride, or combinations thereof at 25° C., and wherein X⁻ is not derived from an acid or anhydride of carbonic acid or carbamic acid.

In some embodiments, the present description provides a Michael Addition curable composition. In an aspect, the composition includes at least one reactive donor capable of providing two or more nucleophilic carbanions. The nucleophilic carbanion refers to an active intermediate of carbon with a lone pair of electrons to which two or three strong electronegative groups are typically attached. Suitable examples of such strong electronegative groups include, without limitation, —NO₂, —C(═O)—, —SO₂—, —CHO, —CN, and —CONR₂, and the like, wherein R₁ and R₂ each independently represent an unsubstituted alkyl group, substituted alkyl group, unsubstituted aryl group, substituted aryl group, substituted and unsubstituted aralkyl group, and the like.

The nucleophilic carbanion of at least one reactive donor is derived from an acidic proton C—H in an activated methylene, methine group, or combinations thereof. In another embodiment, The nucleophilic carbanion of at least one reactive donor is derived from two or more acidic protons C—H in an activated methylene, methine group, or combinations thereof. Suitable examples of species capable of providing the acidic proton C—H include, without limitation, dialkyl malonates (e.g., dimethyl malonate, diethyl malonate, and the like), cyanoacetates (e.g., methyl cyanoacetate, ethyl cyanoacetate, and the like), acetoacetates, propionyl acetates, acetylacetone, dipropionyl methane and the like, and mixture or combination thereof.

The glass transition temperature of the at least one reactive donor is not particularly limited, and will vary depending on the desired end use and performance characteristics of the coating composition described herein. For example, in the instance that a cured coating with optimal hardness is required, it may be advantageous to increase the glass transition temperature of the at least one reactive donor (Tg) to at least 0° C. However, in this exemplary instance, the Tg of the at least one reactive donor should also not be much higher than 40° C. to avoid any negative impact on curing.

In some embodiments, the at least one reactive donor may be obtained by reacting a compound, oligomer, or polymer that may be functionalized to act as a reactive donor backbone with an acetoacetate or malonate compound.

In some embodiments, the at least one reactive donor may comprise a reactive donor having a backbone based on polyester resin, acrylics resin, urethane resin, epoxy resin, or combinations thereof.

Where the at least one reactive donor has a polyester-based backbone, a suitable polyester resin that can be functionalized to act as a reactive donor can be obtained by esterifying an acid component containing a di- or polycarboxylic acid or anhydride thereof with one or more di- or polyhydric alcohols. Suitable examples of the di- or polycarboxylic acid include, without limitation, aliphatic dicarboxylic acids such as, for example, malonic acid, succinic acid, glutaric acid, adipic acid, pimelic acid, suberic acid, azelaic acid, sebacic acid, anhydrides of these acids, and the like, and mixtures or combinations thereof, alicyclic dicarboxylic acids and/or anhydrides, such as 1,3-/1,4-cyclohexanedicarboxylic acid, dicyclohexanemethane-4,4′-dicarboxylic acid, and the like, and aromatic dicarboxylic acids such as, for example, phthalic acid terephthalic acid, isophthalic acid, trimellitic anhydride, anhydrides of these acids, and the like, and mixtures or combinations thereof. Preferred examples of the di- or polyhydric alcohol include, without limitation, trimethylolpropane, pentaerythritol, neopentyl glycol, diethylene glycol, 1,4-butanediol, ethylhexylpropanediol, 2,4-diethyl-1,5-pentanediol, ditrimethylolpropane, dipentaerythritol or any combination thereof.

The polyester resin can be functionalized by, for example, reacting with diketene, transesterifying with an alkyl acetoacetate or dialkyl malonate, esterficiation with malonic acid or a monoester or acid functional malonate polyester and the like. In an aspect, the at least one reactive donor is obtained by transesterification of polyester resin with an alkyl acetoacetate or dialkyl malonate, wherein the malonate or acetoacetate functional group is present in the main chain, as a terminal or end group, or present as both, preferably as a terminal or end group. In another aspect, the at least one reactive donor is obtained by direct transesterification of a di- or polyhydric alcohol with an alkyl acetoacetate or dialkyl malonate, wherein the malonate or acetoacetate functional group is preferably present as a terminal or end group.

In an embodiment, where the at least one reactive donor has an acrylic resin-based backbone, a suitable acrylic resin that can be functionalized to act as a reactive donor can be obtained by copolymerizing an acrylics monomers comprising (meth) acrylic acid, hydroxyl alkyl (meth)acrylate or any combination thereof with one or more other ethylenically unsaturated monomers. The other ethylenically unsaturated monomers include but are not limited to styrenes, for example, styrene, vinyl toluene, o-methyl styrene, p-methyl styrene, a-butyl styrene, 4-n-butyl styrene, 4-n-decyl styrene, halogenated styrene (such as monochlorostyrene, dichlorostyrene, tribromostyrene or tetrabromostyrene); C1-20 alkyl (meth)acrylate esters, examples of which include, without limitation, methyl (meth)acrylate, ethyl (meth)acrylate, propyl (meth)acrylate, isopropyl (meth)acrylate, n-butyl (meth)acrylate, sec-butyl (meth)acrylate, tert-butyl (meth)acrylate, amyl (meth)acrylate, hexyl (meth)acrylate, heptyl (meth)acrylate, octyl (meth)acrylate, 2-octyl (meth)acrylate, 2-ethylhexyl (meth)acrylate, nonyl (meth)acrylate, 2-methyloctyl (meth)acrylate, 2-tert-butyl heptyl (meth)acrylate, 3-isopropylheptyl (meth)acrylate, decyl (meth)acrylate, undecyl (meth)acrylate, 5-methylundecane (meth)acrylate, dodecyl (meth)acrylate, 2-methyldodecyl (meth)acrylate, tridecyl (meth)acrylate, 5-methyltridecyl (meth)acrylate, myristyl (methyl) acrylate, pentadecyl (meth)acrylate, cetyl (meth)acrylate, 2-methylhexadecyl (meth)acrylate, heptadecyl (meth)acrylate, 5-isopropylheptadecyl (meth)acrylate, 5-ethyloctadecyl (meth)acrylate, octadecyl (meth)acrylate, nonadecyl (meth)acrylate, eicosyl (meth)acrylate, cycloalkyl (meth)acrylates (e.g. cyclopentyl (meth)acrylate, cyclohexyl (meth)acrylate, 3-vinyl-2-butylcyclohexyl (meth)acrylate, cycloheptyl (meth)acrylate, cyclooctyl (meth)acrylate, norbornene (meth)acrylate and isonorbornene (meth)acrylate; or any combination thereof. Other acrylics monomers preferably comprise styrene, methylstyrene, methyl (meth)acrylate, ethyl (meth)acrylate, propyl (meth)acrylate, butyl (meth)acrylate or any combination thereof. The acrylics resin can be functionalized by, for example, reacting with diketene, transesterifying with an alkyl acetoacetate or dialkyl malonate, esterficiation with malonic acid or a monoester or acid functional malonate polyester and the like. In a preferred embodiment, the at least one reactive donor is obtained by transesterification of acrylics resin with an alkyl acetoacetate or dialkyl malonate, wherein the malonate or acetoacetate functional group is present in the main chain, as a pendent chain, or present as both, preferably present as a pendent chain. In another preferred embodiment, the acrylic donor can be prepared by polymerizing an activated methylene functional (meth)acrylic monomer with or without any combination of the above mentioned ethylenically unsaturated monomers. Suitable activated methylene functional (meth)acrylic monomers include for example acetoacetoxyethyl methacrylate.

In an embodiment, the at least one reactive donor has a polyurethane-based backbone. An exemplary polyurethane resin that can be functionalized to act as a reactive donor can be obtained by condensing an active hydrogen-containing polymer with one or more polyisocyanates. The term “active hydrogen-containing polymer” as used herein refers to any polymer that itself contains a functional group capable of providing active hydrogen and/or any polymer that contains functional groups capable of being converted into active hydrogen during the preparation and/or application of a reactive donor. Suitable examples include, without limitation, one or more of vinyl acetate-ethylene copolymer, vinyl acetate-ethylene-(meth)acrylate copolymer, vinyl acetate-(methyl) acrylate copolymer, polyvinyl acetate, polyvinyl alcohol, acrylics polymer or copolymer, polyester, polyether, or any combination thereof. Examples of the polyisocyanate include, without limitation, hexamethylene diisocyanate, dodecamethylene diisocyanate, cyclohexane-1,4-diisocyanate, 4,4′-dicyclohexylmethane diisocyanate, cyclopentane-1,3-diisocyanate, benzene-1,4-diisocyanate, toluene-2,4-diisocyanate, naphthalene-1,4-diisocyanate, biphenyl-4,4′-diisocyanate, benzene-1,2,4-triisocyanate, xylene-1,4-diisocyanate, xylene-1,3-diisocyanate, diphenylmethane diisocyanate, butane-1,2,3-triisocyanate or polymethylene polyphenyl polyisocyanate, or polyurethane prepolymer thereof, polyester prepolymer thereof or polyether prepolymer thereof and any combination thereof. The polyurethane resin can be functionalized by, for example, reacting with diketene, transesterifying with an alkyl acetoacetate or dialkyl malonate, esterification with malonic acid or a monoester or acid functional malonate polyester and the like. In a preferred embodiment, the at least one reactive donor is obtained by transesterification of polyurethane resin with an alkyl acetoacetate or dialkyl malonate, wherein the malonate or acetoacetate functional group is present in the main chain, as a terminal or end group, or present as both, preferably as a terminal or end group.

In an embodiment, the at least one reactive donor has an epoxy resin based backbone. Exemplary epoxy resins that can be functionalized to act as a reactive donor include, but are not limited to, bisphenol A epoxy resin, bisphenol F epoxy resin and novolac epoxy resin, and the like, and mixtures or combinations thereof. The epoxy resin can be functionalized by, for example, reacting with diketene, transesterifying with an alkyl acetoacetate or dialkyl malonate, esterification with malonic acid or a monoester or acid functional malonate polyester and the like. In a preferred embodiment, the at least one reactive donor is obtained by transesterification of epoxy resin with an alkyl acetoacetate or dialkyl malonate, wherein the malonate or acetoacetate functional group is present in the main chain, as a terminal or end group, or present as both, preferably present as a terminal or end group

In another embodiment, the at least one reactive donor may comprise at least one reactive diluent obtained from a di- or polyhydric alcohol via transesterification. Suitable examples of the di- or polyhydric alcohols include, but are not limited to, trimethylolpropane, pentaerythritol, neopentyl glycol, diethylene glycol, 1,4-butanediol, ethylhexylpropanediol, 2,4-diethyl-1,5-pentanediol, ditrimethylolpropane, dipentaerythritol or any mixtures or combinations thereof. In many embodiments, at least one reactive donor comprises at least one reactive diluent obtained from at least one diol or at least one polyol via transesterification. In a preferred embodiment, the at least one reactive diluent is obtained by transesterification of a di- or polyhydric alcohol with an alkyl acetoacetate or dialkyl malonate.

In some embodiments, the at least one reactive donor may comprise raw materials for the above at least one reactive diluent, such as di- or polyhydric alcohols, and an alkyl acetoacetate or dialkyl malonate. After being mixed with other components of the MA curable composition, these raw materials for the at least one reactive diluent undergoes transesterification.

Surprisingly, that where the at least one reactive donor comprises at least one reactive diluent obtained from a di- or polyhydric alcohol via transesterification, a MA curable composition with a high solid content and low viscosity can be successfully formulated. For example, the MA curable composition can be formulated to have a solid content of 70 wt % or higher, preferably 80 wt % or higher, more preferably 90 wt % or higher, and a viscosity of 16 seconds or lower, wherein the viscosity is measured using an Iwata-2 type cup at 25° C.

Accordingly, the MA curable composition described herein can be coated directly during application, such as direct spraying without further dilution. This application process significantly reduces VOC emissions. In some embodiments, the MA curable composition containing the reactive diluent has a VOC content of 400 g/L or less as measured by ISO 11890-1: 2007, preferably 200 g/L or less.

Without limiting to theory, it is believed that at least one reactive donor, including at least one reactive diluent of low molecular weight, is advantageous for formulating the MA curable composition described herein, having high solids content and low viscosity. Accordingly, in one embodiment, the above-mentioned reactive diluent has a weight average molecular weight (Mw) of 1000 g/mol or less, preferably of 800 g/mol or less, more preferably of 500 g/mol or less.

In one embodiment, the at least one reactive donor obtained from a di- or polyhydric alcohol via transesterification may contain three or more, preferably four or more, more preferably six or more, still more preferably eight or more acidic protons C—H in activated methylene, methine groups, or combinations thereof. Without limiting to theory, it is noted that the MA curable composition formulated with a reactive donor having at least three acidic proton C—H functional groups can exhibit superior paint film hardness. Surprisingly, the MA curable composition formulated with a reactive donor having six or more, or preferably eight or more acidic protons C—H can even exhibit lower film shrinkage.

In some embodiments, the MA curable composition described herein includes at least one reactive donor having a backbone based on polyester, acrylic, polyurethane, epoxy, or mixtures or combinations thereof, and at least one reactive diluent obtained from a di- or polyhydric alcohol via transesterification. In many embodiments, at least one reactive donor comprises at least one reactive diluent obtained from at least one diol or at least one polyol via transesterification.

The amount of at least one reactive donor is not particularly limited, and may be determined by the desired end use and performance characteristics of the MA curable composition described herein.

The MA curable composition or system described herein includes at least one reactive acceptor. The at least one reactive acceptor may be any organic compound that is electron-deficient and ethylenically unsaturated, i.e. includes at least one carbon-carbon double bond. For example, a suitable reactive acceptor may be an α,β-unsaturated carbonyl compound with a carbonyl group, or other electron withdrawing group occurring alpha to the double bond. In an embodiment, the at least one reactive acceptor described herein includes at least one carbon-carbon double bond. Preferably, the at least one reactive acceptor has two or more carbon-carbon double bonds. Generally, in the process of curing and crosslinking of the composition described herein, the higher the functionality of the acceptor, the higher the crosslink density of the cured product, and the higher the hardness. Surprisingly, when compared to a reaction acceptor containing more than two carbon-carbon double bond groups, such as for example, a reactive acceptor containing three carbon-carbon double bonds or four carbon-carbon double bonds, a reactive acceptor containing two carbon-carbon double bonds is particularly advantageous for improving hardness of cured coatings derived from the MA curable system described herein.

In an embodiment, the carbon-carbon double bond group of the at least one reactive acceptor is a compound having structure represented by formula II:

C═C—CX (Formula II)

in which, CX represents any one of the following groups: alkenyl, alkynyl, aldehyde, ketone, ester, and cyano group. Preferably, the carbon-carbon double bond group is derived from one or more of α, β-unsaturated aldehyde, α, β-unsaturated ketone, α, β-unsaturated carboxylate ester and α, β-unsaturated nitrile, preferably α, β-unsaturated carboxylate esters.

In one embodiment, the at least one reactive acceptor may be selected from one or more of α, β-unsaturated carboxylate esters represented by the following formulae:

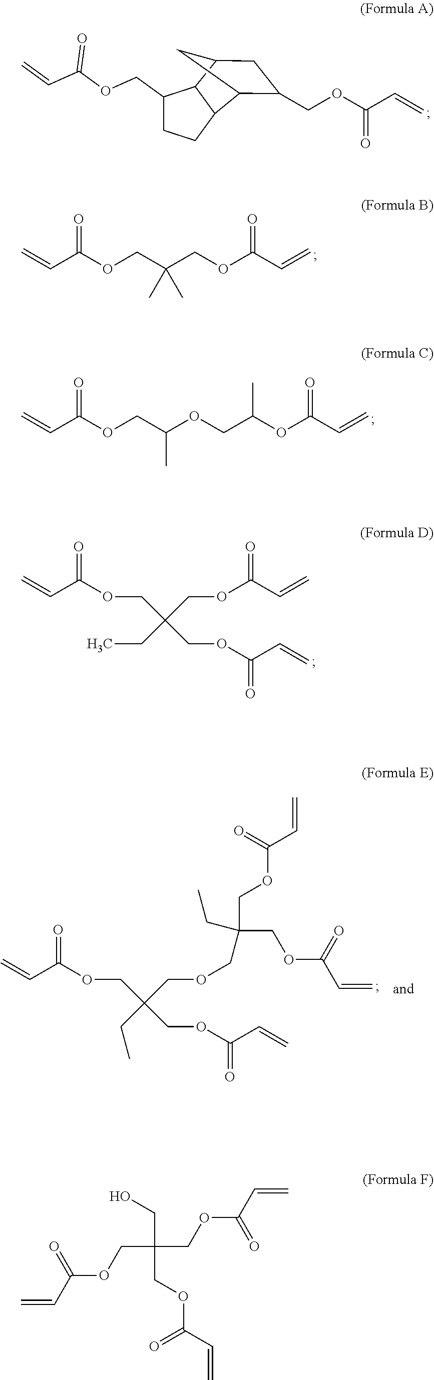

In a preferred embodiment, the at least one reactive acceptor may be selected from one or more of the α, β-unsaturated carboxylate esters represented by Formula A, Formula B and Formula C, most preferably the α, β-unsaturated carboxylate ester represented by formula A.

In other embodiments, suitable examples of the reactive acceptors described herein include, without limitation, ethylenically unsaturated acids and/or esters thereof, including, for example, fumaric, maleic, itaconic acids, and the like, or esters of (meth)acrylic acid, i.e. a (meth)acrylate functional compound derived from the reaction of an hydroxyl functional compound (i) with (meth)acrylic acid or its ester derivatives (ii), wherein the hydroxyl functional compound can be mono-, di-, or polyfunctional and has as a backbone that contains an aliphatic, cycloaliphatic or aromatic chain, a (poly)epoxy, (poly)ether, (poly)ester for example (poly)caprolactone, (poly)alkyd, (poly)urethane, (poly)amine, (poly)amide, (poly)carbonate, (poly)olefin, (poly)siloxane, (poly)acrylate, halogen (e.g. fluorine), a melamine-derivative, copolymers of any of them, and the like, and mixtures and combinations thereof.

The amount of at least one reactive acceptor is not particularly limited, and may be determined by the desired end use and performance characteristics of the MA curable composition described herein. In some embodiments, the mole ratio of the nucleophilic carbanions of the at least one reactive donor to the carbon-carbon double bonds of the at least one reactive acceptor may be in a range of from 0.7:1 to 1.3:1, preferably from 0.8:1 to 1.2:1, and more preferably from 0.9:1 to 1.1:1.

In the MA curable composition described herein, in addition to the at least one reactive donor and at least one reactive acceptor, the composition also comprises resins that do not participate in Michael Addition reaction, including but not limited to polyester resin, acrylics resin, epoxy resin, polyurethane resin, and the like as well as any combinations thereof. The amount of these resins is not particularly limited and may be determined empirically.

The MA curable composition or system described herein includes a catalyst for catalyzing the Michael Addition crosslinking reaction of the at least one reactive acceptor and at least one reactive donor. In some embodiments, the Michael Addition curable composition may further comprise at least one additional catalyst. The presence of the catalyst makes the MA curable composition described herein have an appropriate balance of pot life and curing speed, even at ambient temperature or room temperature.

In an embodiment, the catalyst comprises at least one quaternary salt having the structure of a compound of Formula I,

R¹R²R³R⁴M⁺X⁻ (Formula I)

wherein
R¹, R², R³ and R⁴ are each independently selected from C1-C12 alkyl, C6-C14 aryl, C7-C15 alkaryl, C7-C15 aralkyl and any combination thereof, or any two of R¹, R², R³ and R⁴ together with M atom to which they are attached form a heterocycle;
M is N or P, preferably N; and
X⁻ is derived from at least one acid, at least one anhydride, or combinations thereof, having a pKa value in the range of 0 to 10, preferably in the range of 1 to 8, wherein the pKa value is measured in an aqueous solution of the at least one acid, the at least one anhydride, or combinations thereof at 25° C., and wherein X⁻ is not derived from an acid or anhydride of carbonic acid or carbamic acid.

Surprisingly, and without limiting to theory, it is noted that the pKa value of an acid or anhydride is an important factor that affects catalytic activity of a catalyst formed from the acid or anhydride described herein. In an embodiment, a catalyst having a pKa of less than 10 has optimal catalytic activity. Preferably, the acid or acid anhydride, as well as combinations thereof, has a pKa value in the range of 0 to 10, more preferably in the range of 1 to 8. As an exemplary illustration, the acid or anhydride may have a pKa value in the range of 1 to 2, or in the range of 2-3, or in the range of 3-4, or in the range of 4-5 , or in the range of 5-6, or in the range of 6-7, or in the range of 7-8, or in the range of 1.5-2.5, or in the range of 2.5-3.5 , or in the range of 3.5-4.5, or in the range of 4.5-5.5, or in the range of 5.5-6.5, or in the range of 6.5-7.5, or in the range of 7.5-8.5, or any range consisting of any one of these values and any other value.

Suitable acids and/or anhydrides include, without limitation, one or more of an aliphatic carboxylic acid, an aromatic carboxylic acid, an alicylic carboxylic acid, an inorganic weak acid, any anhydrides thereof, and mixtures or combinations thereof. Preferably, the acid or anhydride includes, for example, one or more of formic acid, acetic acid, oxalic acid, glycolic acid, monohaloacetic acid, dihaloacetic acid, trihaloacetic acid, propionic acid, malonic acid, acrylic acid, lactic acid, propiolic acid, glyceric acid, pyruvic acid, n-butyric acid, isobutyric acid, 3-butenoic acid, succinic acid, maleic acid, tartaric acid, n-valeric acid, isovaleric acid, pentenoic acid, glutaric acid, itaconic acid, citraconic acid, mesaconic acid, glutamic acid, n-hexanoic acid, isohexanoic acid, hexenoic acid, citric acid, sebacic acid, ethylenediaminetetraacetic acid (EDTA), 1,2-cyclohexanedicarboxylic acid, gluconic acid, phthalic acid, trimellitic acid, pyromellitic acid, arsenic acid, hydrofluoric acid, hydroselenoic acid, selenious acid, and anhydride thereof.

In the MA curable composition described herein, tetraalkyl and trialkylaralkyl type salts are preferably used as catalysts. Nitrogen-containing heterocycle salts can also be used, such as those derived from pyridine, piperidine, piperazine or morpholine, for example. Specific examples of cations include, without limitation, tetrabutylammonium cation, tetramethylammonium cation, tetraethylammonium cation, triethylbenzylammonium cation, tetrapropylammonium cation, tetrahexylammonium cation, tetraoctylammonium cation, tetradecyl ammonium cation, tetracetylammonium cation, triethylhexylammonium cation, 2-hydroxyethyltrimethylammonium cation, methyltrioctylammonium cation, hexadecyltrimethylammonium cation, 2-chloroethyltrimethylammonium cation.

The amount of catalyst used herein is not particularly limited and may vary depending on the nature and ultimate end use of the MA curable composition described herein. Preferably, the catalyst is present in an amount of at least 1.0 wt %, preferably at least 1.4 wt %, but preferably not more than 5 wt %, based on the solid amount of the catalyst relative to the total solids of the MA curable composition. In some embodiments, the Michael Addition curable composition may further comprise at least one additional catalyst.

In another embodiment, a Michael Addition curable composition, may comprise: A) at least one reactive donor capable of providing two or more nucleophilic carbanions; B) at least one reactive acceptor comprising two or more carbon-carbon double bonds; C) a catalyst for catalyzing the Michael Addition crosslinking reaction between the at least one reactive donor and the at least one reactive acceptor; and D) a co-catalyst comprising a metal oxide or metal salt, wherein the catalyst comprises at least one quaternary salt with the following structural Formula I:

R¹R²R³R⁴M⁺X⁻ (Formula I)

in which formula,
R¹, R², R³ and R⁴ are each independently selected from C1-C12 alkyl, C6-C14 aryl, C7-C15 alkaryl, C7-C15 aralkyl and any combination thereof, or any two of R¹, R², R³ and R⁴ together with M atom to which they are attached form a heterocycle; M is selected from N or P, preferably from N; and X⁻ is derived from at least one acid, at least one anhydride, or combinations thereof; and wherein the metal oxide or the metal salt has a pH in the range of 8 to 12.

In this embodiment, at least one reactive donor and at least one reactive acceptor are similar as described above. However, quaternary salts, including quaternary ammonium salts, may be derived from acids or anhydrides as the catalysts in the Michael Addition crosslinking reaction between reactive donors and reactive acceptors and to combine it with a metal oxide or metal salt with a specific pH value. Surprisingly, this combination may provide a synergistic effect. The above-mentioned metal oxide or metal salt with a specific pH value can specifically promote the catalytic efficiency of the above-mentioned at least one quaternary salt as a catalyst in the Michael addition crosslinking system, and improve the curing speed of the curing system, especially when the amount of catalyst is significantly reduced. Additionally, Michael addition curing system described herein is particularly suitable for curing at low temperatures and therefore suitable as a coating for coating heat-sensitive substrates (especially wood substrates). In addition, the above-mentioned metal oxides and metal salt can also enhance the hardness of the Michael addition curing system described herein.

Moreover, the Michael Addition-curable system has a wide adaptability and can be applied to various Michael Addition reactions between reactive donors and reactive acceptors based on various resin systems. For example, the Michael Addition-curable system according described herein can be suitable for reaction systems based on epoxy resins, polyester resins, polyacrylic resins, polyurethane resins, binary or polyol-based compounds, or combinations thereof.

In addition to the above-mentioned components, the Michael addition curable composition according to what is described herein may also comprise metal oxides or metal salts. As mentioned above, the metal oxides or metal salts are compounds that are capable of dissociating metal ions when added to the system, and are thus alkaline. In some embodiments, the metal oxide or metal salts have a pH in the range of 8-12. In other embodiments, the metal oxide or metal salts have a pH in the range of 8 to 11, in the range of 8 to 10, in the range of 8 to 9, in the range of 9 to 11, in the range of 9 to 10, or in the range of 10 to 11.

It is well known that metal oxides or metal salts, especially magnesium oxide, aluminum oxide, metal silicates (such as magnesium aluminum silicate) and the like as well as combinations thereof, are usually used in lubricants, food additives, ceramics, animal feed additives and other fields and their application in the field of paint and coating is very rare. Not to be bound by theory, metal oxide or metal salt may specifically promote the catalytic efficiency of the quaternary salt as a catalyst in a Michael addition curing system, and increase the curing speed of the curing system. Therefore, in the context of the present application, such basic metal oxides or metal salts may also be referred to as promoters. Furthermore, the application of the promoter may be particularly suitable for the situation where the amount of catalyst is significantly reduced.

In embodiments according, the metal oxide or metal salts comprise one or more metals selected from alkali metals, alkaline earth metals and aluminum. In some embodiments, the alkali metals are selected from lithium (Li), sodium (Na), potassium (K), rubidium (Rb), cesium (Cs), francium (Fr), preferably sodium and potassium; and the alkaline earth metal is selected from beryllium (Be), magnesium (Mg), calcium (Ca), strontium (Sr), barium (Ba), radium (Ra), preferably magnesium and calcium. In some embodiments, the alkali metal oxide or metal salts comprise one metal selected from alkali metals, alkaline earth metals, and aluminum, and preferably comprise magnesium, aluminum, calcium, or sodium. In some embodiments, the alkali metal oxide or metal salt includes a combination of two or more metals selected from alkali metals, alkaline earth metals and aluminum, such as a combination of aluminum and magnesium or a combination of sodium and aluminum.

In the embodiment described herein where metal oxide(s) are used to promote catalysts, the metal oxides may be selected from one or more of alkali metal oxides, alkaline earth metal oxides, and alumina, preferably selected from magnesium oxide, alumina, or its combination. As an example of magnesium oxide, any commercially available magnesium oxide can be used, such as those commercially available from Wuxi Zehui Chemical Co., Ltd. under the trademarks ZH-V41 and ZH-V2-1. As an example of alumina, any commercially available alumina can be used, such as white corundum 500# or white corundum F800 commercially available from Shandong Luxin Sisha Taishan Abrasive Co., Ltd.

In the embodiment described herein where metal salt(s) are used to promote the catalyst, the metal salts are selected from one or more of metal carbonates and metal silicates, preferably comprising sodium carbonate, calcium carbonate, calcium silicate, sodium aluminum silicate, magnesium aluminum silicate, and combinations thereof. As an example of sodium carbonate, any commercially available sodium carbonate can be used, such as sodium carbonate commercially available from Shandong Haihua Co., Ltd.; as an example of calcium carbonate, any commercially available calcium carbonate can be used, such as calcium carbonate from Shangdong Langfang Qianyao Technology Co., Ltd.; as an example of sodium aluminum silicate, any commercially available sodium aluminum silicate can be used, such as sodium aluminum silicate commercially available from Kunshan Shengan Biological Co., Ltd.; as an example of magnesium aluminum silicate, any commercially available magnesium aluminum silicate can be used, such as the 3M™ Ceramic Microspheres series commercially available from 3M Company, such as W-210, W-410, and W-610 microspheres.

In one embodiment, the amount of metal oxide or metal salts as used herein may vary according to the nature of the composition. Preferably, based on the total weight of the composition, the metal oxide or metal salt is present in an amount of 0.5-50% by weight, preferably in an amount of 1-40% by weight, more preferably in an amount of 1-30% by weight, still more preferably in an amount of 1-20% by weight, even more preferably in an amount of 1 to 10% by weight, even still more preferably in an amount of 1 to 8% by weight, particularly preferably in an amount of 2 to 7% by weight.

Not to be bound by theory, the Michael addition curable composition described herein may contain the above-mentioned basic metal oxide or metal salt may still maintain an appropriate curing speed, even in a very low amount of quaternary salt catalyst, for example, 1.0% by weight or less or 0.9% by weight or less based on the total weight of the composition, which is unexpected prior to the present application.

Not to be bound by theory, Michael addition curable composition described herein containing the above-mentioned metal oxide or metal salts can obtain a coating with significantly improved hardness after curing, compared with the comparable Michael addition curable composition containing no such metal oxide or metal salt.

The MA curable composition as described herein may further comprise one or more solvents in order to adjust viscosity of the composition to obtain the desired processability.

In certain embodiments, the solvent comprises ethanol. Surprisingly, it has been found that incorporation of a certain amount of ethanol in the MA curable composition described herein can result in a longer pot life or gel time for the composition or coating composition formulated therefrom without adversely affecting its cure rate. In certain embodiments, the solvent contains at least about 2 wt %, preferably at least about 5 wt %, more preferably at least about 10 wt % ethanol, relative to the total weight of the solventln many embodiments, the one or more solvent further comprises: (A) an alcohol other than ethanol, (B) esters, (C) ketones, (D) ethers, (E) aliphatic solvents, (F) aromatic solvents, (G) alkylated aromatic solvents, or (H) combinations thereof.

In some embodiments, the solvent may comprise other alcohols, such as methanol, isopropanol, isobutanol, n-propanol, n-butanol, 2-butanol, pentanol, tert-amyl alcohol, neopentyl alcohol, n-hexanol, ethylene glycol, and the like; esters such as ethyl acetate, butyl acetate, methoxypropyl acetate, isobutyl acetate, and the like; ketones such as methyl ethyl ketone, methyl n-amyl ketone, and the like; ethers such as ethylene glycol butyl ether, and the like; aliphatic solvents such as solvent oils, and the like; and aromatic or alkylated aromatic solvents such as toluene, xylene, and the like.

Where the solvent includes alcohols and other non-alcohol solvents, the weight percentage of alcohol solvents and other non-alcohol solvents may each vary within a wide range. Preferably, the alcohol solvent is present in a weight percentage within a range of about 10 wt % to 50 wt %, preferably about 15 wt % to 50 wt %, and more preferably about 20 wt % to 40 wt % relative to the total weight of solvent. Moreover, preferably, the other non-alcohol solvents are present in a weight percentage within a range of about 50 wt % to 90 wt %, preferably 50 wt % to 85 wt %, and more preferably 60 wt % to 80 wt %, relative to the total weight of solvent.

In a specific embodiment, the solvent further comprises butyl acetate, isobutanol, or combinations thereof.

In an embodiment, the amount of solvent may vary within a wide range, preferably within a range of 0.1 wt % to 35 wt % relative to the total weight of the composition. In some embodiments, where the at least one reactive donor comprises at least one reactive diluent, for example, in order to reduce VOC content of the composition, preferably, the composition comprises solvent as low as possible, preferably comprises solvent in an amount of 30 wt % or less, more preferably of 15 wt % or less, even more preferably of 10 wt % or less, relative to the total weight of the composition. In some other embodiments, where the at least one reactive donor comprises over 90 wt % of at least one reactive diluent, for example, the amount of solvent used in the coating composition may be less than 5 wt %, preferably less than 3 wt %, and more preferably less than 2 wt %. In a specific embodiment, such as the at least one reactive donor comprises 100 wt % reactive diluents, the coating composition may not comprise any solvent.

In an embodiment, the composition described herein may optionally further comprise other additional additives commonly used in coating compositions, which additives do not adversely affect the composition or cured product obtained therefrom. Suitable additives comprise, for example, those that improve processing or manufacturing properties of the composition, enhance aesthetics of the composition or cured product obtained therefrom, or improve specific functional properties or characteristics of the composition or cured product obtained therefrom (such as adhesion to the substrate). The additives that may be included are, for example, selected from adhesion promoters, curing accelerators, open time regulators, pigments and fillers, surfactants, lubricants, defoamers, dispersants, UV absorbers, colorants, coalescing agents, thixotropic agents, antioxidants, stabilizers, preservatives, fungicides, or combinations thereof for providing the required performance as needed. The content of each optional ingredient is preferably sufficient to achieve its intended purpose, but does not adversely affect the composition or cured product obtained therefrom.

In some embodiments, the MA curable composition includes an amount of one or more epoxy functional components. The epoxy-functional component can be present as a separate component of the MA curable composition or may be present as a part of reactive donor and/or reactive acceptor in the MA curable composition.

In other embodiments, the MA curable composition is substantially free of epoxy functional components. As used herein, “substantially free of epoxy functional components” means that the composition contains no more than about 3 wt %, preferably no more than about 2.8 wt %, more preferably no more than about 2.5 wt % of the epoxy functional component, relative to the total weight of the composition.

Where the epoxy functional component is added as a separate component to the MA curable composition described herein, the amount of the epoxy functional component is based on the weight of the added individual component relative to the total weight of the MA curable composition. Where the epoxy functional component is added to the MA curable composition by covalently bonding to the reactive donor and/or reactive acceptor, the amount of the epoxy functional component is determined based on the weight of raw material for providing an epoxy functional group relative to the total weight of the MA curable composition.

The MA curable composition described herein is environmentally acceptable, namely, it is substantially free of volatile organic compounds (VOC). In some embodiments, the composition has a VOC content of 420 g/L or less as measured by ISO 11890-1: 2007. In other embodiments, the composition has a VOC content of 400 g/L or less, preferably a VOC content of 200 g/L. The VOC content is determined based on the total weight of the composition.

After components of the MA curable composition described herein are mixed, the resulting composition has a relatively long pot life and shows particularly excellent workability. In one embodiment, after components of the composition are mixed, the resulting mixture has a pot life of 6 hours or more, preferably of 7 hours or more, and more preferably of 8 hours or more, and even more preferably of 10 hours or more at 25° C.

The MA curable composition described herein can be cured at a temperature determined by the application process, the nature of the substrate to which the composition is applied, or the ultimate end use of the composition. In some embodiments, curing is performed at ambient temperature, especially within a range of about 15° C. to 40° C. and preferably within a range of about 20° C. to 27° C. In other embodiments, it can be cured under high temperature baking conditions, such as above 100° C.

The MA curable composition described herein can be cured for an appropriate period of time at a given curing temperature. For example, at room temperature, the curing may be completed within 7 days or less, preferably 5 days or less, more preferably 3 days or less.

In one embodiment, after components of the composition are mixed, the resulting composition is applied at a wet coating thickness of about 100 microns and dried at room temperature for 24 hours. The resulting cured coating shows a pendulum hardness of about 5 or more, preferably of about 20 or more, more preferably of about 40 or more, still more preferably of about 80 or more, even more preferably of 100 or more. “Pendulum hardness,” as used herein, is determined according to ASTM D-4366 (Standard Test Methods for Hardness of Organic Coatings by Pendulum Damping Tests).

The MA curable compositions described herein are suitable for a variety of applications, and can be used for manufacture of coatings, adhesives, sealants, foams, elastomers, films, molded articles, or inks.

Prior to use, the MA curable composition described herein may be stored in various ways. In certain embodiments, components of the Michael Addition curable composition, such as at least one reactive donor, at least one reactive acceptor, and a catalyst, are stored separately. In other embodiments, certain components of the Michael Addition curable composition may be pre-mixed, for example, at least one reactive donor and at least one reactive acceptor may be pre-mixed, and a catalyst may be stored separately, or a catalyst may be pre-mixed with at least one reactive donor or at least one reactive acceptor, and the remaining component is stored separately. Upon using, at least one reactive donor, at least one reactive acceptor, a catalyst and other components are simply mixed in a mixing vessel at a predetermined weight ratio. The mixed curable composition can be shaped using various methods familiar to those skilled in the art, such as by molding, coating, extrusion, and the like. The composition thus obtained can be cured to form a desired cured product. Therefore, what is described herein also relates to a cured product obtained and/or obtainable by the MA curable composition described herein.

The Michael Addition curable composition described herein is particularly suitable for application as a coating composition in the coatings industry. Accordingly, the present description provides a coating composition that includes the MA curable composition described herein. The composition can be applied in a variety of ways familiar to those skilled in the art, including spraying (e.g., air assisted, airless or electrostatic spraying), brushing, rolling, flooding and dipping. In an embodiment described herein, the mixed coating composition is coated by spraying.

The coating composition can be applied at various wet film thicknesses. In an embodiment, the coating composition is applied in a wet film thickness in the range of about 100 to about 400 μm, preferably about 100 to 200 μm. The applied coating may be cured by air drying at room temperature or by accelerating drying with various drying devices e.g., ovens familiar to those skilled in the art.

The present description provides a coated article comprising a substrate having at least one major surface, and a cured coating formed from the coating composition described herein that is directly or indirectly at least partially applied on the major surface.

According to what is described herein, the substrate has at least one, preferably two, major surfaces that are opposite one another. In some embodiments, the major surface of substrate may contain polar groups such as hydroxyl groups, amino groups, mercapto groups, and the like for promoting adhesion. The hydroxyl group on the surface of the substrate may originate from the substrate itself, such as from cellulose when the substrate is a wooden substrate, or may be introduced on the surface of substrate by performing surface treatment on the major surface of substrate, for example, by corona treatment, or by the application of pretreatments to metal substrates, as known to those of skill in the art.

The coating composition described herein may be applied on a variety of substrates. Suitable examples include, without limitation, natural and engineered buildings and building materials, freight containers, flooring materials, walls, furniture, other building materials, motor vehicles, motor vehicle components, aircraft components, trucks, rail cars and engines, bridges, water towers, cell phone tower, wind towers, radio towers, lighting fixtures, statues, billboard supports, fences, guard rails, tunnels, pipes, marine components, machinery components, laminates, equipment components, appliances, and packaging. Exemplary substrates include, without limitation, wood, metal, plastic, ceramic, cement board, or any combination thereof. In one embodiment, the substrate is a wooden substrate. In another embodiment, the substrate is metal, preferably stainless steel.

### EXAMPLES

The following examples describe what is described herein in more detail, which are for illustrative purposes only, since various modifications and changes will be apparent to those skilled in the art from the scope of what is described herein. Unless otherwise indicated, all parts, percentages, and ratios reported in the following examples are on a weight basis and all reagents used in the examples are commercially available and may be used without further treatment.

### Example 1

### Reactive Donor

Reactive donor A1 is a malonate-functional polyester resin that is commercially available as ACURE 510-170 (Allnex USA).

Reactive donor A2 was prepared in the following manner. At room temperature, a four-necked flask equipped with a thermometer, a top stirrer, a gas inlet, and distillation apparatus was charged with 187.40 g of trimethylolpropane, 359.43 g of neopentyl glycol, 86.02 g of adipic acid, and 596.00 g of phthalic anhydride. Nitrogen gas was supplied through the gas inlet for nitrogen protection. Then, the resulting reaction mixture was slowly heated to about 180° C. and maintained at this temperature until distillate water was produced. The temperature of the mixture was raised to 230° C. The mixture was then allowed to stand until an acid value of lower than 2 mg KOH/g was reached. The mixture was then cooled to below 150° C., and then 216.41 g of tert-butyl acetoacetate was added. The temperature of mixture was raised to 120° C. for reaction. The distillate tert-butanol was collected and the mixture was kept at this temperature until the distillation temperature did not exceed 78° C. The temperature of mixture was raised to 160° C. After distillation, the mixture was then cooled to below 100° C. and then mixed with 429.20 g of n-butyl acetate (n-BA) with a solids content of about 70 wt %. The resulting reactive donor A2 has the following properties: Mn=4339; Mw=19494; PDI=4.5; and Tg of 6° C.

Reactive donor A3, an epoxy-based reactive donor, was prepared in the following manner. At room temperature, a four-necked flask equipped with a thermometer, a top stirrer, a gas inlet, and a distillation device was charged with 209.36 g of epoxy resin (NanYa, EEW: 772 g/mol) and 90.64 g of tert-butyl acetoacetate (t-BAA). Nitrogen gas was supplied through the gas inletto provide nitrogen protection. Then, the resulting reaction mixture was slowly heated to about 130° C., the distillate (tert-butanol) collected, and maintained at this temperature until the distillation temperature did not exceed 78° C. The temperature of the mixture was raised to 160° C. After distillation, the mixture was then cooled to below 100° C. and then mixed with 102.96 g of n-butyl acetate (n-BA) with a solids content of about 70%.

Reactive donor A4 is ethyl acetoacetate (CAS No. 141-97-9) with a solid content of approximately 98% and a C—H functionality of 2.

Reactive donor A5, a polyol based reactive donor, was prepared in the following manner. At room temperature, a four-necked flask equipped with a thermometer, a top stirrer, a gas inlet, and a distillation device was charged with 195.4358 g (1.8765 mol) of neopentyl glycol and 604.5642 g (3.7530 mol) of tert-butylacetoacetate. Nitrogen gas was supplied through the gas inlet for providing nitrogen protection. Then, the resulting reaction mixture was slowly heated to about 105° C. and kept at this temperature until the tert-butanol was distilled off, and the distillation temperature was kept at 78° C.±2° C. The temperature of mixture was raised to 170° C. When the temperature of mixture reached 170° C., it was kept for a while until the distillation temperature was below 60° C. The mixture was then cooled to below 60° C. The resulting reactive donor has the following properties: molecular weight is 272.29 g/mol; solid content is about 91%; viscosity does not exceed 300 mPa·s at 25° C.; C—H functionality is 4.

Reactive donor A6, a polyol-based reactive donor, was prepared in the following manner. At room temperature, a four-necked flask equipped with a thermometer, a top stirrer, a gas inlet, and a distillation device was charged with 251.451 g (1.8765 mol) of trimethylolpropane and 906.8463 g (5.6295 mol) of tert-butylacetoacetate. Nitrogen gas was supplied through the gas inlet for providing nitrogen protection. Then, the resulting reaction mixture was slowly heated to about 105° C. and kept at this temperature until the tert-butanol was distilled off, and the distillation temperature was kept at 78° C.±2° C. The temperature of mixture was raised to 170° C. When the temperature of mixture reached 170° C., it was kept for a while until the distillation temperature was below 60 C. The mixture was then cooled to below 60° C. The resulting reactive donor has the following properties: molecular weight is 386.38 g/mol; solid content is about 91.3%; viscosity does not exceed 300 mPa·s at 25° C.; C—H functionality is 6.

Reactive donor A7 is a polyol based reactive donor that was prepared in the following manner. At room temperature, a four-necked flask equipped with a thermometer, a top stirrer, a gas inlet, and a distillation device was charged with 255.485 g (1.8765 mol) of pentaerythritol and 1187.37414 g (7.506 mol) of tert-butylacetoacetate. Nitrogen gas was supplied through the gas inlet for providing nitrogen protection. Then, the resulting reaction mixture was slowly heated to about 105° C. and kept at this temperature until the tert-butanol was distilled off, and the distillation temperature was kept at 78° C.±2° C. Under this distillation temperature of no more than 78° C., the temperature of mixture was raised to 170° C. When the temperature of mixture reached 170° C., it was kept for a while until the distillation temperature was below 60° C. The mixture was then cooled to below 60° C. The resulting reactive donor has the following properties: molecular weight is 472.43 g/mol; solid content is about 91.6%; viscosity is 350 mPa·s at 25° C.; C—H functionality is 8.

### Example 2

### Reactive Acceptor

Reactive acceptor B1 is an acid-free tetra-functional polyester acrylate resin commercially available as ACURE 550-105 (Allnex USA).

Reactive acceptor B2 is a low viscosity, difunctional acrylate monomer commercially available as Sartomer SR833 (Arkema USA).

Reactive acceptor B3 is a dipropylene glycol diacrylate (DPGDA).

Reactive acceptor B4 is a trimethylolpropane triacrylate (TMPTA).

Reactive acceptor B5 is ditrimethylolpropane acrylate (Di-TMPTA).

### Example 3

### Catalyst

Catalysts C1 to C18 were prepared as follows. Each acid or anhydride shown in Table 1 below was added dropwise to an aqueous solution of tetrabutylammonium hydroxide. For each acid listed in Table 1, the amount of acid was such that the stoichiometric ratio of —OH to —COOH was 1:1. Similarly, for each anhydride used, the stoichiometric ratio is 2:1. If necessary, a certain amount of ethanol can be added to promote dissolution of the acid or anhydride. A catalyst solution with a solid content of 20% by weight was obtained.

TABLE 1

| Catalyst | Acid or | | |
|---|---|---|---|
| No. | anhydride | Structure | pKa |
| C1 | Acetic acid | 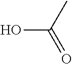 | 4.74 |
| C2 | Maleic acid | 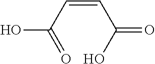 | pKa1 = 1.92 pKa2 = 6.23 |
| C3 | Maleic anhydride | 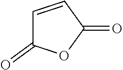 | pKa1 = 1.92 pKa2 = 6.23 |
| C4 | Acrylic acid | 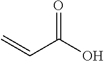 | 4.25 |
| C5 | Malonate | 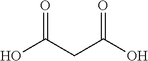 | pKa1 = 2.83 pKa2 = 5.70 |
| C6 | Citric acid | 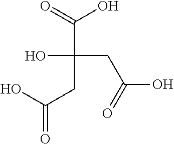 [SMILES: O=C(O)CC(O)(CC(=O)O)C(=O)O] | pKa1 = 3.09 pKa2 = 4.74 pKa3 = 5.41 |
| C7 | Succinic acid | 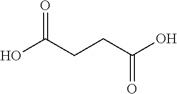 | pKa1 = 4.16 pKa2 = 5.61 |
| C8 | Succinic anhydride | 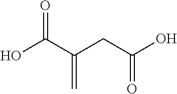 | pKa1 = 4.16 pKa2 = 5.61 |
| C9 | Itaconic acid | 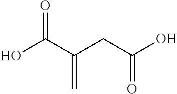 | pKa1 = 3.85 pKa2 = 5.45 |
| C10 | Hexa- hydrophthalic anhydride | 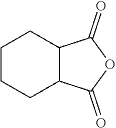 [SMILES: O=C1OC(=O)C2CCCCC12] | pKa1 = 4.34 pKa2 = 6.76 |
| C11 | Phthalic anhydride | 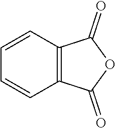 [SMILES: O=C1OC(=O)c2ccccc21] | pKa1 = 2.89 pKa2 = 5.51 |
| C12 | Pyromellitic dianhydride | 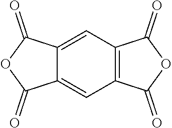 [SMILES: O=c1oc(=O)c2cc3c(=O)oc(=O)c3cc12] | pKa1 = 1.92 pKa2 = 2.87 pKa3 = 4.49 pKa4 = 5.63 |
| C13 | Trimellitic anhydride | 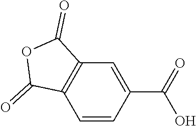 [SMILES: O=C(O)c1ccc2c(c1)C(=O)OC2=O] | pKa1 = 2.52 pKa2 = 3.84 pKa3 = 5.20 |
| C14 | Hydrogen | HF | 3.17 |
| | fluoride | | |
| C15 | Hydrogen | HCl | −8.0 |
| | chloride | | |
| C16 | Hydrogen | HBr | −9.0 |
| | bromide | | |
| C17 | Nitric acid | HNO₃ | −1.3 |
| C18 | Fluoroboric | HBF₄ | −4.9 |
| | acid | | |

| | |
|---|---|
| C19 | Acure 500 commercially available from Allnex |

### Example 4

### Preparation of MA Curable Coating Compositions

Various MA curable test compositions were prepared and are listed as Examples 1-1 to 1-19 and Comparative Examples 1-1 to 1-4 in Table 2. Each MA curable composition was formulated using a reactive donor, a reactive acceptor, a solvent, and a catalyst as shown in Table 2, and the solvent was butyl acetate. In Examples 1-1 to 1-14 and Comparative Examples 1-1 to 1-4, the weight ratio of reactive donor Al, reactive acceptor Bl, solvent, and catalyst was 60:28:36:10. In Examples 1-15 to 1-19, the weight ratio of reactive donor A2, reactive acceptor B2, solvent and catalyst was 287:83:45:41. After mixing the reactive donor, the reactive acceptor, the catalyst, and the solvent, a certain amount of butyl acetate was selectively added to adjust viscosity of composition, thereby forming the MA-curable compositions of Examples 1-1 to 1-19 and Comparative Examples 1-1 to 1-4.

### Example 5

### Cure Properties

To determine the effect of catalyst on the cure of MA curable compositions, the test compositions prepared as described in Example 4 and shown in Table 2 were applied to an aluminum test substrate at a wet coating thickness of 100 microns, and cured at 25° C. The time required for curing, i.e. the time required for the coating to be dry to the touch by hand, was recorded in Table 2.

TABLE 2

| | Reactive | Reactive | | Curing |
|---|---|---|---|---|
| | Donor | Acceptor | Catalyst | Time (h) |
| Example 1-1 | A1 | B1 | C1 | 3 |
| Example 1-2 | A1 | B1 | C2 | 2 |
| Example 1-3 | A1 | B1 | C3 | 1 |
| Example 1-4 | A1 | B1 | C4 | 8 |
| Example 1-5 | A1 | B1 | C5 | 2 |
| Example 1-6 | A1 | B1 | C6 | 2 |
| Example 1-7 | A1 | B1 | C7 | 2 |
| Example 1-8 | A1 | B1 | C8 | 2 |
| Example 1-9 | A1 | B1 | C9 | 2 |
| Example 1-10 | A1 | B1 | C10 | 1 |
| Example 1-11 | A1 | B1 | C11 | 1 |
| Example 1-12 | A1 | B1 | C12 | 1 |
| Example 1-13 | A1 | B1 | C13 | 2 |
| Example 1-14 | A1 | B1 | C14 | 2 |
| Example 1-15 | A2 | B2 | C1 | 1 |
| Example 1-16 | A2 | B2 | C2 | 3 |
| Example 1-17 | A2 | B2 | C4 | 8 |
| Example 1-18 | A2 | B2 | C5 | 2 |
| Example 1-19 | A2 | B2 | C14 | 1 |
| Comparative | A1 | B1 | C15 | Not curing |
| Example 1-1 | | | | within 24 h |
| Comparative | A1 | B1 | C16 | Not curing |
| Example 1-2 | | | | within 24 h |
| Comparative | A1 | B1 | C17 | Not curing |
| Example 1-3 | | | | within 24 h |
| Comparative | A1 | B1 | C18 | Not curing |
| Example 1-4 | | | | within 24 h |

It can be seen from Table 2 that when the catalyst is a quaternary salt derived from an acid or anhydride with pKa value in the range of 0-10, the MA curable composition is capable of cure at room temperature or ambient temperature.

### Example 6

### Performance Testing

The test compositions prepared as described in Example 4 and shown in Table 2 were tested for pendulum hardness. A pendulum hardness tester (BYK-Gardner GmbH) was used to test pendulum hardness according to ASTM D-4366. The test compositions were tested for pendulum hardness after being allowed to cure for a specific number of days. The resulting pendulum hardness was expressed in counts and the results are shown in Table 3.

TABLE 3

| | 1 d | 2 d | 3 d | 4 d | 5 d | 6 d | 7 d | 15 d |
|---|---|---|---|---|---|---|---|---|
| Example 1-1 | 6 | 7 | / | 10 | 11 | 16 | 21 | 27 |
| Example 1-2 | 50 | 47 | / | 54 | 51 | 57 | 67 | 72 |
| Example 1-4 | x | x | / | 6 | 7 | 6 | 8 | 12 |
| Example 1-5 | 27 | 26 | / | 41 | 39 | 45 | 55 | 55 |
| Example 1-14 | 41 | 49 | / | 71 | 72 | 80 | 98 | 97 |
| Example 1-15 | 96 | 128 | 129 | 135 | / | 131 | 131 | 139 |
| Example 1-16 | 108 | 127 | 130 | 117 | / | 122 | 120 | 119 |
| Example 1-17 | 9 | 108 | 127 | 126 | / | 121 | 121 | 138 |
| Example 1-18 | 52 | 119 | 121 | 122 | / | 122 | 122 | 121 |
| Example 1-19 | 107 | 124 | 130 | 121 | / | 124 | 124 | 131 |

Note:
“x” as shown in Table 3 means uncured and “/” as shown in table 3 means that the data was not tested.

The results in Table 3 indicate that the MA curable compositions described herein provide a cured coating with optimal, even superior, hardness.

### Example 7

### Effect of Reactive Diluent

To determine the effect of using at least one reactive diluent, test samples of Michael Addition-curable compositions were made. These test samples are designated as Examples 2-1 to 2-10 in Table 4. The test samples were formulated with at least one reactive diluent as the reactive donor, together with a reactive acceptor and a catalyst, wherein the reactive donor and the reactive acceptor were as shown in Table 2, and the catalyst was C14 with a solid content of 25 wt %. No solvent was used.

In Example 2-11, epoxy based reactive donor A3 and the reactive diluent A7 with a C—H functionality of 8 were mixed as a reactive donor.

After the compositions of Examples 2-1 to 2-11 were formulated, their solid content (wt %), viscosity and VOC content were tested and recorded in Table 4, wherein the solid content and VOC content were measured according to GB/T23985-22209/ISO 11890-1: 2007, and the viscosity was measured using an Iwata-2 type cup at 25° C.

Each of the test compositions labeled Examples 2-1 to 2-11 were applied to an aluminum test substrate at a wet coating thickness of 100 microns, and cured at 25° C. The pendulum hardness of these cured coatings were tested at a specific number of days of curing according to ASTM D-4366 using a pendulum hardness tester (BYK-Gardner GmbH), with the results expressed in counts and recorded in Table 4.

In addition, the test compositions each were placed in plastic cups and cured at room temperature. The shrinkage of each composition was observed with the naked eye, and the results were recorded in Table 4.

TABLE 4

| | | | Solid | | | Pendulum | | |
|---|---|---|---|---|---|---|---|---|
| | Reactive | Reactive | content | Viscosity | VOC | hardness | | |
| | donor | acceptor | (wt %) | (s) | (g/L) | 1 d | 2 d | Shrinkage |
| Example 2-1 | A4 | B3 | / | / | 60 | x | x | / |
| Example 2-2 | A4 | B4 | / | / | 76 | 10 | 11 | Severe |
| Example 2-3 | A5 | B3 | / | / | 91 | 9 | 8 | Severe |
| Example 2-4 | A5 | B4 | / | / | 100 | 110 | 118 | Severe |
| Example 2-5 | A6 | B3 | / | / | 90 | 19 | 40 | Very slight |
| Example 2-6 | A6 | B4 | / | / | 99 | 122 | 123 | Severe |
| Example 2-7 | A7 | B3 | / | / | 88 | 39 | 72 | Very slight |
| Example 2-8 | A7 | B4 | / | / | 99 | 125 | 128 | Slight |
| Example 2-9 | A7 | B3 + B4 | 96.0 | 15.20 | 40.26 | 102 | / | / |
| | | B3:B4 = 41:22 | | | | | | |
| Example 2-10 | A7 | B3 + B5 | 96.2 | 15.97 | 37.50 | 104 | / | / |
| | | B3:B5 = 41:22 | | | | | | |
| Example 2-11 | A3 + A7 | B3 + B4 | 60.0 | 15.50 | 400 | 105 | 120 | Very slight |
| | A3:A7 = 96:4 | B3:B4 = 41:22 | | | | | | |

Note:
“x” as shown in Table 4 means uncured and “/” as shown in table 4 means that the data was not tested.

The results in Table 4 demonstrate that MA curable compositions containing a reactive diluent could be successfully cured and were suitable for use in coating compositions. Moreover, the MA curable composition containing the reactive donor had a high solids content and low viscosity with low VOC content. Therefore, these compositions could be used without further dilution by adding solvents during application, thereby reducing VOC emissions to atmospheric environment.

The hardness test results shown in Table 4 demonstrate that the MA curable composition described herein containing the reactive diluent have optimal, even superior hardness. Furthermore, when reactive donors with higher C—H functionality were used, the resulting MA curable compositions also exhibited additional benefits, such as excellent film shrinkage.

### Example 8

### Effect of Solvent on Pot Life

To determine the effect of solvent on pot life, various MA curable test compositions were prepared and designated as Samples 1-10 and Examples 3-1 to 3-4 in Table 5. The test compositions were formulated using a reactive donor, a reactive acceptor, a solvent, and a catalyst. The reactive donor is a mixture of A3 and A7 with a A3:A7 weight ratio of 2.3:1, and the reactive acceptor is a mixture of B3 and B4 with a B3:B4 weight ratio of 12:30. The catalyst is C14 with a solid content of 50%, and the solvent used was as shown in Table 5. The weight ratio of reactive donors, reactive acceptors, solvent and catalyst was 62:33:30:3.6.

After mixing the reactive donors, reactive acceptors, catalyst, and solvent, the resulting mixture was placed in a glass bottle. In order to quickly screen more preferred solvents, the above mixture was placed in a constant temperature water bath at 40° C., and its viscosity was periodically tested, using an Iwata-2 type cup.

In tables 5-8, the used solvents were abbreviated as follows: n-Butyl acetate as BAC; ethanol as EtOH; isopropyl alcohol as IPA; isobutyl alcohol as IBA; propylene glycol monomethyl ether acetate as PMA, and methyl amyl ketone as MAK.

Viscosity results at 40° C. are shown in Table 5.

TABLE 5

| | | Initial | 1 h | 1.5 h | 2 h | 2.5 h |
|---|---|---|---|---|---|---|
| Temperature | Solvents | 20° C. | 40° C. | 40° C. | 40° C. | 40° C. |
| Sample 1 | 100% BAC | 18″50 | Gelled | | | |
| Sample 2 | 60% BAC + 40% EtOH | 17″56 | 18″09 | 18″95 | 22″09 | 50″88 |
| Sample 3 | 60% BAC + 40% IPA | 19″16 | Gelled | | | |
| Sample 4 | 60% BAC + 40% IBA | 19″65 | Gelled | | | |
| Sample 5 | 60% BAC + 40% PMA | 20″81 | Gelled | | | |
| Sample 6 | 80% BAC + 20% EtOH | 18″03 | 25″19 | Gelled | | |
| Sample 7 | 80% BAC + 20% IPA | 18″84 | Gelled | | | |
| Sample 8 | 80% BAC + 20% IBA | 19″31 | Gelled | | | |
| Sample 9 | 60% BAC + 20% IPA + | 18″22 | 24″37 | 1′08″85 | | |
| | 20% EtOH | | | | | |
| Sample 10 | 70% BAC + 20% IBA + | 19″19 | Gelled | | | |
| | 20% MAK | | | | | |

Please note: the compositions of the above samples gelled at 40° C. in an hour 1 hour. This does not mean that the composition is not suitable for practical application. The compositions have acceptable pot life at 25° C., such as 6 hours or more.

The results in Table 5 demonstrate that a solvent mixture of butyl acetate and ethanol provides the coating composition with the longest pot life. Adding ethanol to the solvent is particularly beneficial to extend pot life of these compositions.

### Example 9

### Effect of Temperature on Pot Life

To determine the effect of temperature on the pot life of MA curable compositions, various test compositions using various mixing schemes of butyl acetate, isobutanol, and ethanol were used, as shown in the following tables. Table 6, Table 7, and Table 8 show viscosity of the MA curable test compositions of Examples 3-1 to 3-4 as a function of time at temperatures of 28° C., 30° C., and 35° C.

TABLE 6

| | | Initial | 1 h | 1.5 h | 2 h | 2.5 h | 3 h | 4 h | 5 h | 6 h |
|---|---|---|---|---|---|---|---|---|---|---|
| Temperature | Solvents | 20° C. | 28° C. | 28° C. | 28° C. | 28° C. | 28° C. | 28° C. | 28° C. | 28° C. |
| Example 3-1 | 60% BAC + 20% IBA + | 12″72 | 12″16 | 12″75 | 12″62 | 13″34 | 14″15 | 15″37 | 17″59 | 22″28 |
| | 20% EtOH | | | | | | | | | |
| Example 3-2 | 70% BAC + 15% IBA + | 12″78 | 12″22 | 12″75 | 13″25 | 14″06 | 15″32 | 18″22 | 25″05 | 40″81 |
| | 15% EtOH | | | | | | | | | |
| Example 3-3 | 80% BAC + 10% IBA + | 12″56 | 12″97 | 13″71 | 14″69 | 15″44 | 18″66 | 24″16 | 44″19 | Gelled |
| | 10% EtOH | | | | | | | | | |
| Example 3-4 | 90% BAC + 5% IBA + | 12″85 | 13″16 | 14″66 | 17″19 | 20″22 | 30″87 | 1′37″35 | Gelled | |
| | 5% EtOH | | | | | | | | | |

At a curing temperature of 28° C., the MA curable compositions described herein have pot life of more than 3 hours, when a mixture of butyl acetate, isobutanol, and ethanol is used as the solvent.

TABLE 7

| | | Initial | 1 h | 1.5 h | 2 h | 2.5 h | 3 h | 4 h | 5 h |
|---|---|---|---|---|---|---|---|---|---|
| Temperature | Solvent | 22° C. | 30° C. | 30° C. | 30° C. | 30° C. | 30° C. | 30° C. | 30° C. |
| Example 3-1 | 60% BAC + 20% IBA + | 12″19 | 12″34 | 13″10 | 13″63 | / | / | 17″47 | 22″22 |
| | 20% EtOH | | | | | | | | |
| Example 3-2 | 70% BAC + 15% IBA + | 12″25 | 12″12 | 13″00 | 14″03 | / | / | 22″56 | 38″25 |
| | 15% EtOH | | | | | | | | |
| Example 3-3 | 80% BAC + 10% IBA + | 12″16 | 12″22 | 13″53 | 14″75 | / | / | 48″65 | Gelled |
| | 10% EtOH | | | | | | | | |
| Example 3-4 | 90% BAC + 5% IBA + | 12″57 | 13″22 | 15″00 | 18″53 | / | / | Gelled | |
| | EtOH5% | | | | | | | | |

Note:
“/” as shown in table 7 means that the data was not tested.

At a curing temperature of 30° C., the MA curable composition described herein shows pot life of more than 2.5 hours when a mixture of butyl acetate, isobutanol, and ethanol is used as the solvent.

TABLE 8

| | | Initial | 1 h | 1.5 h | 2 h | 2.5 h | 3 h | 4 h | 5 h | 6 h |
|---|---|---|---|---|---|---|---|---|---|---|
| Temperature | Solvents | 21° C. | 35° C. | 35° C. | 35° C. | 35° C. | 35° C. | 35° C. | 35° C. | 35° C. |
| Example 3-1 | 60% BAC + 20% IBA + | 12″25 | 11″78 | 12″47 | 13″57 | 15″91 | 22″97 | 39″97 | 1′10″57 | Gelled |
| | 20% EtOH | | | | | | | | | |
| Example 3-2 | 70% BAC + 15% IBA + | 12″15 | 12″00 | 13″09 | 15″41 | 20″72 | 45″96 | Gelled | | |
| | 15% EtOH | | | | | | | | | |
| Example 3-3 | 80% BAC + 10% IBA + | 12″13 | 13″00 | 14″44 | 18″79 | 34″40 | Gelled | | | |
| | 10% EtOH | | | | | | | | | |
| Example 3-4 | 90% BAC + 5% IBA + | 12″59 | 15″07 | 19″50 | 45″47 | Gelled | | | | |
| | 5% EtOH | | | | | | | | | |

As can be seen from the results shown in Table 8, at a curing temperature of 35° C., the MA curable coating composition described herein shows a pot life of more than 2 hours, when a mixture of butyl acetate, isobutanol, and ethanol is used as the solvent.

### Example 9

### Comparison with Other Michael Addition Catalysts

To compare the MA catalyst described herein, and a previously known MA catalyst that is commercially available, MA curable compositions of Examples 4-1 to 4-7 and Comparative Examples 4-1 to 4-7 were formulated using a reactive donor, a reactive acceptor, a solvent and a catalyst. For Examples 4-1 to 4-7, the reactive donor is a mixture of A3 and A7 with a A3:A7 weight ratio of 2.3:1, the reactive acceptor is a mixture of B3 and B4 with a B3:B4 weight ratio of 12:30, and the catalyst C14 with a solids content of 50%. In Comparative Examples 4-1 to 4-7, the catalyst used was ACURE 500, a blocked latent base catalyst commercially available from Allnex USA. For all compositions in this example, the solvent used was butyl acetate, where the weight ratio of reactive donors, reactive acceptors, and solvent was 55.5:32:17.

After mixing components of the compositions of Examples 4-1 to 4-7 and Comparative Examples 4-1 to 4-7, pot life was measured. Each composition in Examples 4-1 to 4-7 was applied to a test substrate at a wet coating thickness of 200 microns, and cured at room temperature. The pendulum hardness of the coating was tested according to ASTM D-4366 using a BYK-Gardner pendulum hardness tester after 18 hours of cure. The resulting pendulum hardness was expressed in counts and the results are recorded in Table 9.

TABLE 9

| | | Amount | | | |
|---|---|---|---|---|---|
| | | of | Pendulum | | |
| | Catalyst | Catalyst | Hardness | Gel time | |
| Example 4-1 | C14 | 1.0% | 61 | >2 | h |
| Example 4-2 | C14 | 1.2% | 45 | >2 | h |
| Example 4-3 | C14 | 1.4% | 89 | >2 | h |
| Example 4-4 | C14 | 1.8% | 100 | 2 | h |
| Example 4-5 | C14 | 2.0% | 105 | 1 | h |
| Example 4-6 | C14 | 2.2% | 85 | 50 | min |
| Example 4-7 | C14 | 2.4% | 115 | 40 | min |
| Comparative Example 4-1 | Acure500 | 1.0% | 86 | 35 | min |
| Comparative Example 4-2 | Acure500 | 1.2% | 87 | 30 | min |
| Comparative Example 4-3 | Acure500 | 1.4% | 83 | 30 | min |
| Comparative Example 4-4 | Acure500 | 1.8% | 65 | 20 | min |
| Comparative Example 4-5 | Acure500 | 2.0% | 64 | 20 | min |
| Comparative Example 4-6 | Acure500 | 2.2% | 77 | 20 | min |
| Comparative Example 4-7 | Acure500 | 2.4% | 66 | 20 | min |

As can be seen from the results shown in Table 9, the MA curable composition with the catalyst as described herein demonstrated superior properties including better hardness and longer pot life relative to the system using a known commercially available alternate catalyst.

### Example 10

### Effect of Co-Catalyst on Catalytic Activity of Catalyst

The metal oxide or metal salt D1-D5 listed in Table 10 were used as co-catalyst in the following Examples.

TABLE 10

| No. | Type | pH | Solubility |
|---|---|---|---|
| D1 | Magnesium oxide | 9.43 | Slightly soluble |
| D2 | Aluminum oxide | 8.04 | Slightly soluble |
| D3 | Sodium carbonate | 10.61 | Completely soluble |
| D4 | Calcium carbonate | 8.93 | Slightly soluble |
| D5 | Magnesium aluminum | 9.64 | Slightly soluble |
| | silicate(ceramic beads) | | |

The examples in this section examine the effect of co-catalyst, i.e., metal oxide or salts, on the catalytic activity of catalysts in various system.

The Michael Addition curable compositions of Examples 5-1 to 5-10 and Comparative Examples 5-11 to 5-18 were formulated using a reactive donor, a reactive acceptor, a solvent, a catalyst and a co-catalyst with a weight ratio of (donor, acceptor, and additives):catalyst:co-catalyst:solvent=100:3.6:4:30, wherein the specific type of reactive donor, the reactive acceptor, the catalyst and the co-catalyst used in each Example were shown in Table 11, and the solvent was a mixture of 90 wt % of butyl acetate and 10% wt % of ethanol. After mixing the reactive donor, the reactive acceptor, the catalyst, and the solvent, a certain amount of butyl acetate may be selectively added to adjust viscosity of composition, thereby forming the Michael Addition-curable compositions. The Comparative Examples 5-11 to 5-17 did not contain the co-catalyst component; Comparative Example 5-17 and 5-18 were the Michael Addition curable systems as formulated with the Acure catalyst (C19).

The components described in the examples and comparative examples shown in Table 11 below were mixed, and then the time required for the resulting mixture to reach the non-flowable gel state was measured, and then the gel time was recorded in Table 11.

TABLE 11

| | | | | Co- | | |
|---|---|---|---|---|---|---|
| | Donor | Acceptor | Catalyst | catalyst | Gel Time | |
| Example 5-1 | A3 | B2 | C14 | D1 | 15 | min |
| Example 5-2 | A3 | B2 | C14 | D2 | 60 | min |
| Example 5-3 | A3 | B2 | C14 | D3 | 90 | min |
| Example 5-4 | A3 | B2 | C14 | D4 | 20 | min |
| Example 5-5 | A3 | B2 | C14 | D5 | 60 | min |
| Example 5-6 | A2 | B2 | C14 | D1 | 15 | min |
| Example 5-7 | A2 | B2 | C1 | D1 | 15 | min |
| Example 5-8 | A2 | B2 | C2 | D1 | 10 | min |
| Example 5-9 | A2 | B2 | C4 | D1 | 10 | min |
| Example 5-10 | A2 | B2 | C5 | D1 | 30 | min |
| C-Example 5-11 | A3 | B2 | C14 | / | >4 | h |
| C-Example 5-12 | A2 | B2 | C14 | / | >4 | h |
| C-Example 5-13 | A2 | B2 | C1 | / | >24 | h |
| C-Example 5-14 | A2 | B2 | C2 | / | 16 | h |
| C-Example 5-15 | A2 | B2 | C4 | / | >24 | h |
| C-Example 5-16 | A2 | B2 | C5 | / | 16 | h |
| C-Example 5-17 | A1 | B2 | C19 | / | >4 | h |
| C-Example 5-18 | A1 | B2 | C19 | D1 | >4 | h |

It was shown from the results in Table 11 that, compared with the comparable Michael addition curable system without the above-mentioned metal oxides or metal salts, the metal oxides or metal salts significantly improved the curing speed of the Michael addition curable system containing the quaternary salt as a catalyst, but did not work for those containing the latent catalyst Acure 500 commercially available from Allnex.

In addition, it was also shown from the results in Table 11 that the above-mentioned metal oxide or metal salt with a specific pH value promoted the quaternary salt catalyst in both epoxy curing system and polyester curing system and did not affected by the reactive donor and reactive acceptor of the curing system.

### Example 11

### Michael Addition Curable Composition with Reduced Amount of Catalyst

As we found the addition of co-catalyst to the Michael Addition curable compositions can greatly shorten the gel time of the composition, then we studied compositions with reduced amount of catalyst. Examples 6-2 to 6-10 shown in Table 12 used less amount of catalyst comparing with Example 6-1. Their gel time was tested and recorded in Table 12.

TABLE 12

| | Weight ratio of | | |
|---|---|---|---|
| | (A1 + B1 + additives):C14:D1:solvent | Gel Time | |
| Example 6-1 | 100:3.6:4:30 | 15 | min |
| Example 6-2 | 100:3.2:4:30 | 15 | min |
| Example 6-3 | 100:2.8:4:30 | 30 | min |
| Example 6-4 | 100:2.4:4:30 | 40 | min |
| Example 6-5 | 100:2.0:4:30 | 1 | h |
| Example 6-6 | 100:1.8:4:30 | 2 | h |
| Example 6-7 | 100:1.6:4:30 | 2 | h |
| Example 6-8 | 100:1.4:4:30 | 2.5 | h |
| Example 6-9 | 100:1.2:4:30 | 3 | h |
| Example 6-10 | 100:1.0:4:30 | >4 | h |

It was shown from the results in Table 12 that even if the amount of the quaternary ammonium catalyst was reduced by three times, the Michael addition curing system described herein exhibited a comparable curing speed since contains a metal oxide, compared with the standard Michael Addition curable system without the metal oxide.

### Example 12

### Effect of Co-Catalyst on Coating Hardness of Michael Addition Curing System

The examples in this section examine effect of metal oxide or salts on coating hardness of epoxy based Michael Addition curing system.

The compositions prepared in Examples 5-2 and 5-5 and Comparative Example 5-11 as shown in Table 12 above were coated on an aluminum substrate with a wet coating thickness of 200 microns, and dried at room temperature for different days, and then measured according to ASTM D-4366 for the pendulum hardness of the cured coating. The results were recorded in Table 13 below.

TABLE 13

| | 1 day | 2 days | 3 days | 5 days | 10 days |
|---|---|---|---|---|---|
| Example 5-2 | 84 | 105 | 111 | 119 | 121 |
| Example 5-5 | 112 | 130 | 132 | 133 | 134 |
| C-Example 5-11 | 78 | 103 | 107 | 109 | 112 |

It was shown from the results in Table 13 that the metal oxide or metal salt described herein improved the coating hardness of the Michael addition curing system.

### Embodiments

The following embodiments are contemplated. All combinations of features and embodiments are contemplated.

Embodiment 1: A Michael Addition curable composition, comprising: A) at least one reactive donor capable of providing two or more nucleophilic carbanions; B) at least one reactive acceptor comprising two or more carbon-carbon double bonds; and C) a catalyst for catalyzing the Michael Addition crosslinking reaction between the at least one reactive donor and the at least one reactive acceptor, wherein the catalyst comprises at least one quaternary salt having the structure of a compound of Formula I,

R¹R²R³R⁴M⁺X⁻ (Formula I)

in which formula,
R¹, R², R³ and R⁴ are each independently selected from C1-C12 alkyl, C6-C14 aryl, C7-C15 alkaryl, C7-C15 aralkyl and any combination thereof or any two of R¹, R², R³ and R⁴ together with M atom to which they are attached form a heterocycle;
M is N or P; and
X⁻ is derived from at least one acid, at least one anhydride, or combinations thereof, wherein X⁻ has a pKa value in the range of 0 to 10, wherein the pKa value is the pKa value obtained by measuring an aqueous solution of the at least one acid, the at least one anhydride, or combinations thereof at 25° C., and wherein X⁻ is not derived from an acid or anhydride of carbonic acid or carbamic acid.

Embodiment 2: An embodiment of Embodiment 1, wherein the X⁻ is derived from the at least one acid, the at least one anhydride, or combinations thereof, having a pKa value in the range of 1 to 8.

Embodiment 3: An embodiment of any of Embodiments 1 to 2, wherein the at least one acid comprises one or more of an aliphatic carboxylic acid, an aromatic carboxylic acid, an alicylic carboxylic acid, an inorganic weak acid, or anhydride thereof, and any combination thereof.

Embodiment 4: An embodiment of any of Embodiments 1 to 3, wherein the at least one acid or at least one anhydride comprises one or more of formic acid, acetic acid, oxalic acid, glycolic acid, monohaloacetic acid, dihaloacetic acid, trihaloacetic acid, propionic acid, malonic acid, acrylic acid, lactic acid, propiolic acid, glyceric acid, pyruvic acid, n-butyric acid, isobutyric acid, 3-butenoic acid, succinic acid, maleic acid, tartaric acid, n-valeric acid, isovaleric acid, pentenoic acid, glutaric acid, itaconic acid, citraconic acid, mesaconic acid, glutamic acid, n-hexanoic acid, isohexanoic acid, hexenoic acid, citric acid, sebacic acid, ethylenediaminetetraacetic acid (EDTA), 1,2-cyclohexanedicarboxylic acid, gluconic acid, phthalic acid, trimellitic acid, pyromellitic acid, arsenic acid, hydrofluoric acid, hydroselenoic acid, selenious acid, and anhydride thereof.

Embodiment 5: An embodiment of any of Embodiments 1 to 4, wherein the at least one reactive donor comprises two or more acidic protons C—H in an activated methylene, methine group, or combinations thereof.

Embodiment 6: An embodiment of Embodiment 5, wherein the two or more acidic protons C—H in the activated methylene, methine group, or combinations thereof are derived from an acetoacetate or a malonate compound.

Embodiment 7: An embodiment of any of Embodiments 1 to 6, wherein the at least one reactive donor comprises a reactive donor having a backbone based on an epoxy resin, a polyester resin, an acrylics resin, a polyurethane resin, or combinations thereof.

Embodiment 8: An embodiment of any of Embodiments 1 to 7, wherein the at least one reactive donor comprises at least one reactive diluent obtained from at least one diol or at least one polyol via transesterification.

Embodiment 9: An embodiment of any of Embodiments 1-8, wherein the Michael Addition curable composition has a solid content of 70 wt % or more, preferably of 80 wt % or more and more preferably of 90 wt % or more.

Embodiment 10: An embodiment of any of Embodiments 1-9, wherein the Michael Addition curable composition has a volatile organic compounds (VOC) content of 400 g/L or less as measured by ISO 11890-1: 2007.

Embodiment 11: An embodiment of any of Embodiments 1 to 10, wherein the at least one reactive acceptor comprises a carbon-carbon double bond having the structure of Formula II below:

C═C—CX (Formula II)

wherein CX represents any one of an aldehyde group (—CHO), a keto group (—CO—), an ester group (—C(O)O—), and a cyano group (—CN).

Embodiment 12: An embodiment of any of Embodiments 1 to 11, further comprising one or more solvents.

Embodiment 13: An embodiment of Embodiment 12, wherein the one or more solvents comprise ethanol.

Embodiment 14: An embodiment of Embodiment 12, wherein the one or more solvent further comprises: (A) an alcohol other than ethanol, (B) esters, (C) ketones, (D) ethers, (E) aliphatic solvents, (F) aromatic solvents, (G) alkylated aromatic solvents, or (H) combinations thereof.

Embodiment 15: An embodiment of Embodiment 12, wherein the one or more solvents further comprises butyl acetate, isobutyl alcohol, or combinations thereof.

Embodiment 16: An embodiment of any of Embodiments 1 to 14 further comprising at least one additional catalyst.

Embodiment 17: An embodiment of any of Embodiments 1 to 16, wherein after the components of the composition are mixed, the resulting mixture has a pot life of 2 hours or more at 25° C.

Embodiment 18: An embodiment of any of Embodiments 1 to 17, wherein the Michael Addition curable composition is cured at a range of 20° C. to 27° C.

Embodiment 19: An embodiment of any of Embodiments 1 to 18, wherein the Michael Addition curable composition is cured within 7 days or less at a range of 20° C. to 27° C.

Embodiment 20: A coating composition, comprising the composition according to any one of Embodiments 1 to 19.

Embodiment 21: An embodiment of Embodiment 20, wherein the coating composition is applied at a wet coating thickness of 100 microns and dried for 24 hours to form a cured coating, and wherein the cured coating exhibits a pendulum hardness of about 5 or more as measured by ASTM D-4366.

Embodiment 22: A coated article comprising: 1) a substrate having at least one major surface; and 2) a cured coating formed from the coating composition of any of Embodiments 20 or 21 that is directly or indirectly at least partially applied on the major surface.

Embodiment 23: An embodiment of Embodiment 22, wherein the substrate comprises wood, metal, plastic, ceramic, cement board, or any combination thereof.

Embodiment 24: A Michael Addition curable composition, comprising: A) at least one reactive donor capable of providing two or more nucleophilic carbanions; B) at least one reactive acceptor comprising two or more carbon-carbon double bonds; C) a catalyst for catalyzing the Michael Addition crosslinking reaction between the at least one reactive donor and at least one reactive acceptor; and D) a co-catalyst comprising at least one metal oxide, at least one metal salts, or combinations thereof, wherein the catalyst comprises at least one quaternary salt with the following structural Formula I,

R¹R²R³R⁴M⁺X⁻ (Formula I)

in which formula,
R¹, R², R³ and R⁴ are each independently selected from C1-C12 alkyl, C6-C14 aryl, C7-C15 alkaryl, C7-C15 aralkyl and any combination thereof, or any two of R¹, R², R³ and R⁴ together with M atom to which they are attached form a heterocycle;
M is selected from N or P, preferably from N; and
X⁻ is derived from at least one acid, at least one anhydride thereof, or combinations thereof; wherein the metal oxide, metal salts, or combinations thereof have a pH in the range of 8 to 12.

Embodiment 25: An embodiment of Embodiment 24, wherein X⁻ is derived from the at least one acid, the at least one anhydride, or combinations thereof, having a pKa value in the range of 1 to 8.

Embodiment 26: An embodiment of any of Embodiments 24 to 25, wherein the at least one acid comprises one or more of an aliphatic carboxylic acid, an aromatic carboxylic acid, an alicylic carboxylic acid, an inorganic weak acid, or anhydride thereof, and any combination thereof.

Embodiment 27: An embodiment of any of Embodiments 24 to 26, wherein the at least one acid or at least one anhydride comprises one or more of formic acid, acetic acid, oxalic acid, glycolic acid, monohaloacetic acid, dihaloacetic acid, trihaloacetic acid, propionic acid, malonic acid, acrylic acid, lactic acid, propiolic acid, glyceric acid, pyruvic acid, n-butyric acid, isobutyric acid, 3-butenoic acid, succinic acid, maleic acid, tartaric acid, n-valeric acid, isovaleric acid, pentenoic acid, glutaric acid, itaconic acid, citraconic acid, mesaconic acid, glutamic acid, n-hexanoic acid, isohexanoic acid, hexenoic acid, citric acid, sebacic acid, ethylenediaminetetraacetic acid (EDTA), 1,2-cyclohexanedicarboxylic acid, gluconic acid, phthalic acid, trimellitic acid, pyromellitic acid, arsenic acid, hydrofluoric acid, hydroselenoic acid, selenious acid, and anhydride thereof.

Embodiment 28: An embodiment of any of Embodiments 24 to 27, wherein the at least one reactive donor comprises two or more acidic protons C—H in an activated methylene, methine group, or combinations thereof.

Embodiment 29: An embodiment of Embodiment 28, wherein the two or more acidic protons C—H in the activated methylene, methine group, or combinations thereof are derived from an acetoacetate or a malonate compound.

Embodiment 30: An embodiment of any of Embodiments 24 to 29, wherein the at least one reactive donor comprises a reactive donor having a backbone based on an epoxy resin, a polyester resin, an acrylics resin, a polyurethane resin, or combinations thereof.

Embodiment 31: An embodiment of any of Embodiments 24 to 30, wherein the at least one reactive donor comprises at least one reactive diluent obtained from at least one diol or at least one polyol via transesterification.

Embodiment 32: An embodiment of any of Embodiments 24 to 31, wherein the Michael Addition curable composition has a solid content of 70 wt % or more, preferably of 80 wt % or more and more preferably of 90 wt % or more.

Embodiment 33: An embodiment of any of Embodiments 24 to 32, wherein the Michael Addition curable composition has a volatile organic compounds (VOC) content of 400 g/L or less as measured by ISO 11890-1: 2007.

Embodiment 34: An embodiment of any of Embodiments 24 to 33, wherein the at least one reactive acceptor comprises a carbon-carbon double bond having the structure of Formula II below:

C═C—CX (Formula II)

wherein CX represents any one of an aldehyde group (—CHO), a keto group (—CO—), an ester group (—C(O)O—), and a cyano group (—CN).

Embodiment 35: An embodiment of any of Embodiments 24 to 34, further comprising one or more solvents.

Embodiment 36: An embodiment of Embodiment 35, wherein the one or more solvents comprise ethanol.

Embodiment 37: An embodiment of Embodiment 35, wherein the one or more solvents comprise: (A) an alcohol other than ethanol, (B) esters, (C) ketones, (D) ethers, (E) aliphatic solvents, (F) aromatic solvents, (G) alkylated aromatic solvents, or (H) combinations thereof.

Embodiment 38: An embodiment of Embodiment 35, wherein the one or more solvents further comprise butyl acetate, isobutyl alcohol, or combinations thereof.

Embodiment 39: An embodiment of any of Embodiments 24 to 38, wherein after the components of the composition are mixed, the resulting mixture has a pot life of 2 hours or more at 25° C.

Embodiment 40: An embodiment of any of Embodiments 24 to 39, wherein the Michael Addition curable composition is cured at a range of 20° C. to 27° C.

Embodiment 41: An embodiment of any of Embodiments 24 to 40, wherein the Michael Addition curable composition is cured within 7 days or less at a range of 20° C. to 27° C.

Embodiment 42: An embodiment of any of Embodiments 24 to 41, wherein at least one metal oxide comprises magnesium oxide, aluminum oxide, metal silicates, and combinations thereof.

Embodiment 43: An embodiment of any of Embodiments 23 to 42, wherein at least one metal salt comprises one or more of metal carbonates and metal silicates selected from sodium carbonate, calcium carbonate, calcium silicate, sodium aluminum silicate, magnesium aluminum silicate, and combinations thereof.

Embodiment 44: A coating composition, comprising the composition according to any one of Embodiments 24 to 43.

Embodiment 45: An embodiment of Embodiment 44, wherein the coating composition is applied at a wet coating thickness of 100 microns and dried for 24 hours to form a cured coating, and wherein the cured coating exhibits a pendulum hardness of about 5 or more as measured by ASTM D-4366.

Embodiment 46: A coated article comprising: 1) a substrate having at least one major surface; and 2) a cured coating formed from the coating composition of claim 44 that is directly or indirectly at least partially applied on the at least one major surface.

Embodiment 47: An embodiment of Embodiment 46, wherein the substrate comprises wood, metal, plastic, ceramic, cement board, or any combination thereof.

The complete disclosure of all patents, patent applications, and publications, and electronically available material cited herein are incorporated by reference. The foregoing detailed description and examples have been given for clarity of understanding only. No unnecessary limitations are to be understood therefrom. What is disclosed herein is not limited to the exact details shown and described, for variations obvious to one skilled in the art will be included within what is described herein and defined by the claims. What is disclosed herein may be practiced, in some embodiments, in the absence of any element which is not specifically disclosed herein.

What is claimed is:

1. A Michael Addition curable composition, comprising:
A) at least one reactive donor capable of providing two or more nucleophilic carbanions;
B) at least one reactive acceptor comprising two or more carbon-carbon double bonds; and
C) a catalyst for catalyzing the Michael Addition crosslinking reaction between the at least one reactive donor and the at least one reactive acceptor,
wherein the catalyst comprises at least one quaternary salt having the structure of a compound of Formula I,
R¹R²R³R⁴M⁺X⁻ (Formula I)
in which formula,
R¹, R², R³ and R⁴ are each independently selected from C1-C12 alkyl, C6-C14 aryl, C7-C15 alkaryl, C7-C15 aralkyl and any combination thereof or any two of R¹, R², R³ and R⁴ together with M atom to which they are attached form a heterocycle;
M is N or P; and
X⁻ is derived from at least one acid, at least one anhydride, or combinations thereof, wherein X⁻ has a pKa value in the range of 0 to 10, wherein the pKa value is the pKa value obtained by measuring an aqueous solution of the at least one acid, the at least one anhydride, or combinations thereof at 25° C., and wherein X⁻ is not derived from an acid or anhydride of carbonic acid or carbamic acid.

2. The Michael Addition curable composition according to claim 1, wherein the X⁻ is derived from the at least one acid, the at least one anhydride, or combinations thereof, having a pKa value in the range of 1 to 8.

3. The Michael Addition curable composition according to claim 1, wherein the at least one acid comprises one or more of an aliphatic carboxylic acid, an aromatic carboxylic acid, an alicylic carboxylic acid, an inorganic weak acid, or anhydride thereof, and any combination thereof.

4. The Michael Addition curable composition according to claim 1, wherein the at least one acid or the at least one anhydride comprises one or more of formic acid, acetic acid, oxalic acid, glycolic acid, monohaloacetic acid, dihaloacetic acid, trihaloacetic acid, propionic acid, malonic acid, acrylic acid, lactic acid, propiolic acid, glyceric acid, pyruvic acid, n-butyric acid, isobutyric acid, 3-butenoic acid, succinic acid, maleic acid, tartaric acid, n-valeric acid, isovaleric acid, pentenoic acid, glutaric acid, itaconic acid, citraconic acid, mesaconic acid, glutamic acid, n-hexanoic acid, isohexanoic acid, hexenoic acid, citric acid, sebacic acid, ethylenediaminetetraacetic acid (EDTA), 1,2-cyclohexanedicarboxylic acid, gluconic acid, phthalic acid, trimellitic acid, pyromellitic acid, arsenic acid, hydrofluoric acid, hydroselenoic acid, selenious acid, and anhydride thereof.

5. The Michael Addition curable composition according to claim 1, wherein the at least one reactive donor comprises two or more acidic protons C—H in an activated methylene, methine group, or combinations thereof.

6. The Michael Addition curable composition according to claim 5, wherein the two or more acidic protons C—H in the activated methylene, methine group, or combinations thereof are derived from an acetoacetate or a malonate compound.

7. The Michael Addition curable composition according to claim 1, wherein the at least one reactive donor comprises a reactive donor having a backbone based on an epoxy resin, a polyester resin, an acrylics resin, a polyurethane resin, or combinations thereof.

8. The Michael Addition curable composition according to claim 1, wherein the at least one reactive donor comprises at least one reactive diluent obtained from at least one diol or at least one polyol via transesterification.

9-10. (canceled)

11. The Michael Addition curable composition according to claim 1, wherein the at least one reactive acceptor comprises a carbon-carbon double bond having the structure of Formula II below:
C═C—CX (Formula II)
wherein CX represents any one of an aldehyde group (—CHO), a keto group (—CO—), an ester group (—C(O)O—), and a cyano group (—CN).

12. (canceled)

13. The Michael Addition curable composition according to claim 1 further comprising ethanol.

14. The Michael Addition curable composition according to claim 1 further comprising: (A) an alcohol other than ethanol, (B) esters, (C) ketones, (D) ethers, (E) aliphatic solvents, (F) aromatic solvents, (G) alkylated aromatic solvents, or (H) combinations thereof.

15. (canceled)

16. The Michael Addition curable composition according to claim 1 further comprising at least one additional catalyst.

17-19. (canceled)

20. A coating composition, comprising the Michael Addition curable composition according to claim 1.

21. (canceled)

22. A coated article comprising
a substrate having at least one major surface; and
a cured coating formed from the coating composition of claim 20 that is directly or indirectly at least partially applied on the major surface;
wherein the substrate comprises wood, metal, plastic, ceramic, cement board, or any combination thereof.

23. (canceled)

24. A Michael Addition curable composition, comprising:
A) at least one reactive donor capable of providing two or more nucleophilic carbanions;
B) at least one reactive acceptor comprising two or more carbon-carbon double bonds;
C) a catalyst for catalyzing the Michael Addition crosslinking reaction between the at least one reactive donor and the at least one reactive acceptor; and
D) a co-catalyst comprising at least one metal oxide, at least one metal salt, or combinations thereof,
wherein the catalyst comprises at least one quaternary salt with the following structural Formula I,
R¹R²R³R⁴M⁺X⁻ (Formula I)
in which formula,
R¹, R², R³ and R⁴ are each independently selected from C1-C12 alkyl, C6-C14 aryl, C7-C15 alkaryl, C7-C15 aralkyl and any combination thereof, or any two of R¹, R², R³ and R⁴ together with M atom to which they are attached form a heterocycle;
M is selected from N or P, preferably from N; and
X⁻ is derived from at least one acid, at least one anhydride thereof, or combinations thereof;
wherein the metal oxide, metal salts, or combinations thereof have a pH in the range of 8 to 12.

25. The Michael Addition curable composition according to claim 24, wherein the X⁻ is derived from the least one acid, the least one anhydride, or combinations thereof, having a pKa value in the range of 1 to 8.

26. The Michael Addition curable composition according to claim 24, wherein the at least one acid comprises one or more of an aliphatic carboxylic acid, an aromatic carboxylic acid, an alicylic carboxylic acid, an inorganic weak acid, or anhydride thereof, and any combination thereof.

27. The Michael Addition curable composition according to claim 24, wherein the at least one acid or the at least one anhydride comprises one or more of formic acid, acetic acid, oxalic acid, glycolic acid, monohaloacetic acid, dihaloacetic acid, trihaloacetic acid, propionic acid, malonic acid, acrylic acid, lactic acid, propiolic acid, glyceric acid, pyruvic acid, n-butyric acid, isobutyric acid, 3-butenoic acid, succinic acid, maleic acid, tartaric acid, n-valeric acid, isovaleric acid, pentenoic acid, glutaric acid, itaconic acid, citraconic acid, mesaconic acid, glutamic acid, n-hexanoic acid, isohexanoic acid, hexenoic acid, citric acid, sebacic acid, ethylenediaminetetraacetic acid (EDTA), 1,2-cyclohexanedicarboxylic acid, gluconic acid, phthalic acid, trimellitic acid, pyromellitic acid, arsenic acid, hydrofluoric acid, hydroselenoic acid, selenious acid, and anhydride thereof.

28. The Michael Addition curable composition according to claim 24, wherein the at least one reactive donor comprises two or more acidic protons C—H in an activated methylene, methine group, or combinations thereof.

29. The Michael Addition curable composition according to claim 28, wherein the two or more acidic protons C—H in the activated methylene, methine group, or combinations thereof are derived from an acetoacetate or a malonate compound.

30. The Michael Addition curable composition according to claim 24, wherein the at least one reactive donor comprises a reactive donor having a backbone based on an epoxy resin, a polyester resin, an acrylics resin, a polyurethane resin, or combinations thereof.

31. The Michael Addition curable composition according to claim 24, wherein the at least one reactive donor comprises at least one reactive diluent obtained from at least one diol or at least one polyol via transesterification.

32-33. (canceled)

34. The Michael Addition curable composition according to claim 24, wherein the at least one reactive acceptor comprises a carbon-carbon double bond having the structure of Formula II below:
C═C—CX (Formula II)
wherein CX represents any one of an aldehyde group (—CHO), a keto group (—CO—), an ester group (—C(O)O—), and a cyano group (—CN).

35. (canceled)

36. The Michael Addition curable composition according to claim 24 further comprising ethanol.

37. The Michael Addition curable composition according to claim 24 further comprising: (A) an alcohol other than ethanol, (B) esters, (C) ketones, (D) ethers, (E) aliphatic solvents, (F) aromatic solvents, (G) alkylated aromatic solvents, or (H) combinations thereof.

38-41. (canceled)

42. The Michael Addition curable composition according to claim 24, wherein at least one metal oxide comprises magnesium oxide, aluminum oxide, metal silicates, and combinations thereof.

43. The Michael Addition curable composition according to claim 24, wherein at least one metal salt comprises one or more of metal carbonates and metal silicates selected from sodium carbonate, calcium carbonate, calcium silicate, sodium aluminum silicate, magnesium aluminum silicate, and combinations thereof.

44. A coating composition, comprising the Michael Addition curable composition according to claim 24.

45. (canceled)

46. A coated article comprising:
a substrate having at least one major surface; and
a cured coating formed from the coating composition of claim 44 that is directly or indirectly at least partially applied on the at least one major surface;
wherein the substrate comprises wood, metal, plastic, ceramic, cement board, or any combination thereof.

47. (canceled)
